(19) United States
(12) Patent Application Publication
(10) Pub. No.: US 2026/0037109 A1
(43) Pub. Date: Feb. 5, 2026

(54) REPLACING NODES OF A NODE GRAPH

(71) Applicant: Apple Inc., Cupertino, CA (US)

(72) Inventors: Kenneth J. Hill, Boulder, CO (US); James G. McCarter, Erie, CO (US); Stuart Mark Pomerantz, Boulder, CO (US)

(21) Appl. No.: 19/283,805

(22) Filed: Jul. 29, 2025

Related U.S. Application Data
(60) Provisional application No. 63/677,730, filed on Jul. 31, 2024.

(51) Int. Cl. G06F 3/0484; G06F 3/0482; G06F 17/11

(52) U.S. Cl. CPC G06F 3/0484; G06F 3/0482; G06F 17/11

(57) ABSTRACT

In one implementation, a method of generating a node graph is performed at a device including a display, one or more processors, and non-transitory memory. The method includes displaying, on the display, a node graph including a plurality of nodes associated with a respective plurality of mathematical operations. The method includes selecting a subset of the plurality of nodes defining a mathematical function. The method includes, in response to detecting a trigger, replacing the subset of the plurality of nodes with a function node associated with the mathematical function.

### CROSS-REFERENCE TO RELATED APPLICATIONS

This application claims priority to U.S. Provisional Patent App. No. 63/677,730, filed on Jul. 31, 2024, which is hereby incorporated by reference in its entirety.

### TECHNICAL FIELD

The present disclosure generally relates a user interface for generating a node graph.

### BACKGROUND

In various applications, a node graph can be generated to define output values. For example, the output value may be the color of a point on a surface of a virtual object based on the location of the point on the surface. As a node graph may include a large number of nodes, it may be difficult to visualize the entire node graph or obtain a complete understanding of the node graph to be able to make meaningful modifications.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates a physical setting with an electronic device surveying the physical setting.

FIGS. 2A-2P illustrate the electronic device of FIG. 1 displaying a graphical user interface (GUI) for generating a node graph.

FIGS. 3A-3C illustrate tree graphs of the formula of the custom function node of FIG. 2M in accordance with some implementations.

FIGS. 4A-4C illustrate graphs of an example formula in accordance with some implementations.

FIGS. 5 is a flowchart representation of a method of generating a scene graph in accordance with some implementations.

FIG. 6 is a block diagram of an electronic device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for generating a node graph. In various implementations, the method is performed at a device including a display, one or more processors, and non-transitory memory. In various implementations, the method includes displaying, on the display, a node graph including a plurality of nodes associated with a respective plurality of mathematical operations. The method includes selecting a subset of the plurality of nodes defining a mathematical function. The method includes, in response to detecting a trigger, replacing the subset of the plurality of nodes with a function node associated with the mathematical function.

In accordance with some implementations, a device includes one or more processors, a non-transitory memory, and one or more programs; the one or more programs are stored in the non-transitory memory and configured to be executed by the one or more processors. The one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices, and circuits have not been described in exhaustive detail so as not to obscure more pertinent aspects of the example implementations described herein.

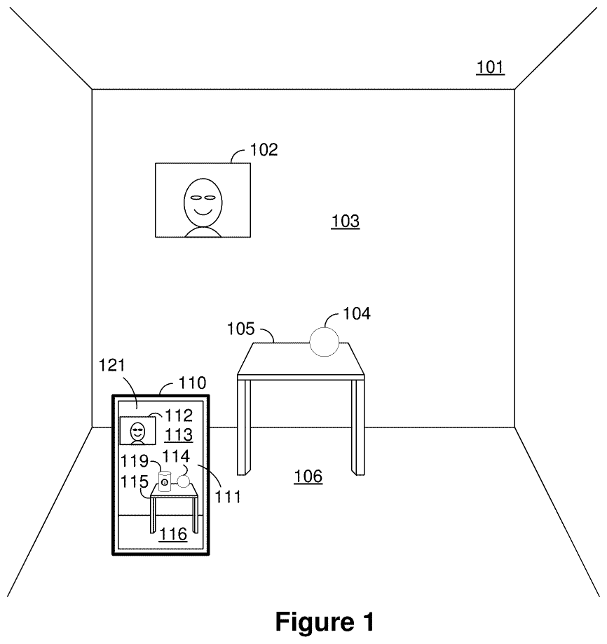

FIG. 1 illustrates a physical environment 101 with an electronic device 110 surveying the physical environment 101. The physical environment 101 includes a picture 102 hanging on a wall 103, a table 105 on a floor 106, and a ball 104 on the table 105.

The electronic device 110 displays, on a display, an image of an XR environment 121 which includes a representation of the physical environment 111 and a representation of a virtual object 119. In various implementations, the representation of the physical environment 111 is generated based on an image of the physical environment 101 captured with one or more cameras of the electronic device 110 having a field-of-view directed toward the physical environment 101. Suitable cameras include scene cameras, event cameras, depth cameras, and so forth. Accordingly, the representation of the physical environment 111 includes a representation of the picture 112 hanging on a representation of the wall 113, a representation of the table 115 on a representation of the floor 116, and a representation of the ball 114 on the representation of the table 115.

In addition to the representations of real objects of the physical environment 101, the image of the XR environment 121 includes a representation of the virtual object 119. The visual appearance of virtual object 119 is defined by software on the electronic device 110. The electronic device 110 presents virtual object 119 as resting on the top surface of the representation of the table 115 by accounting for the position and orientation of device 110 relative to table 105.

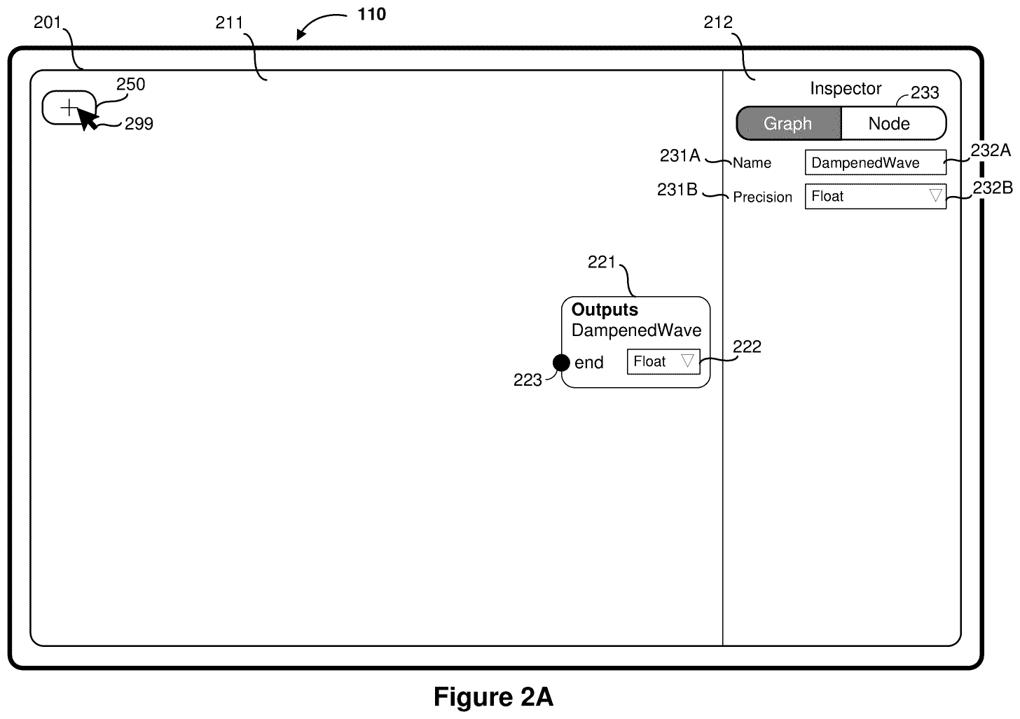

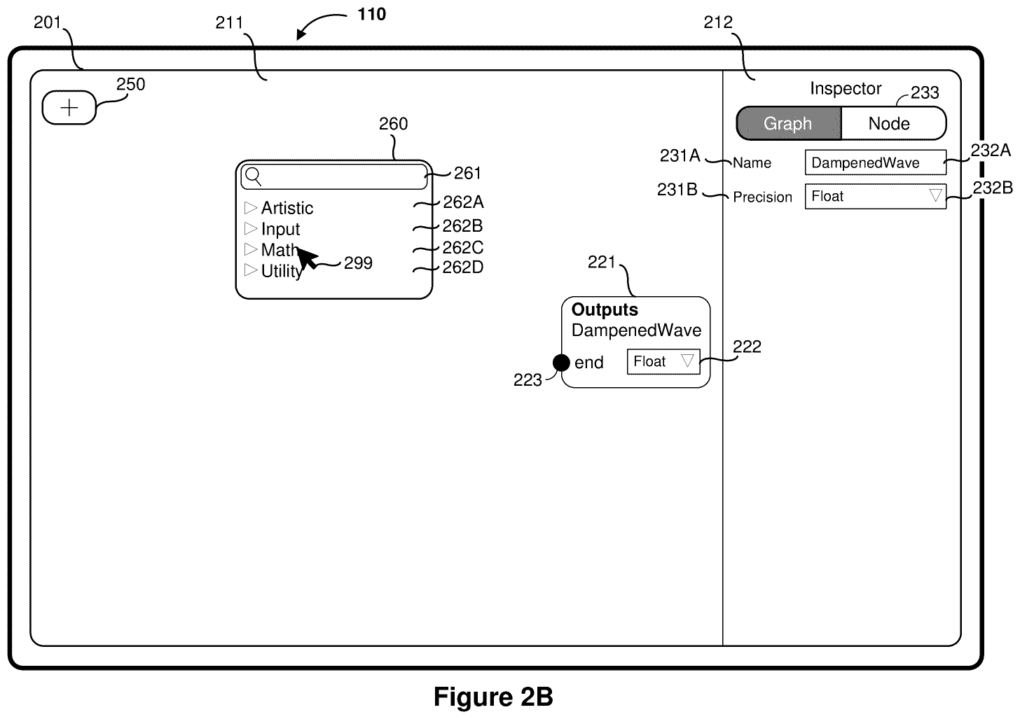

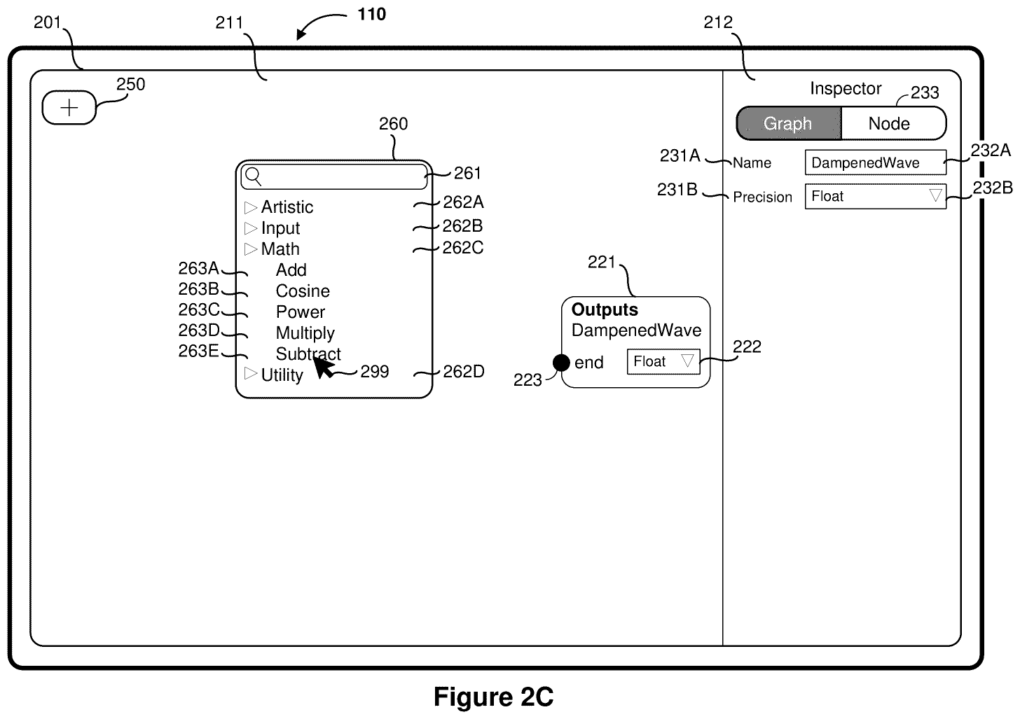

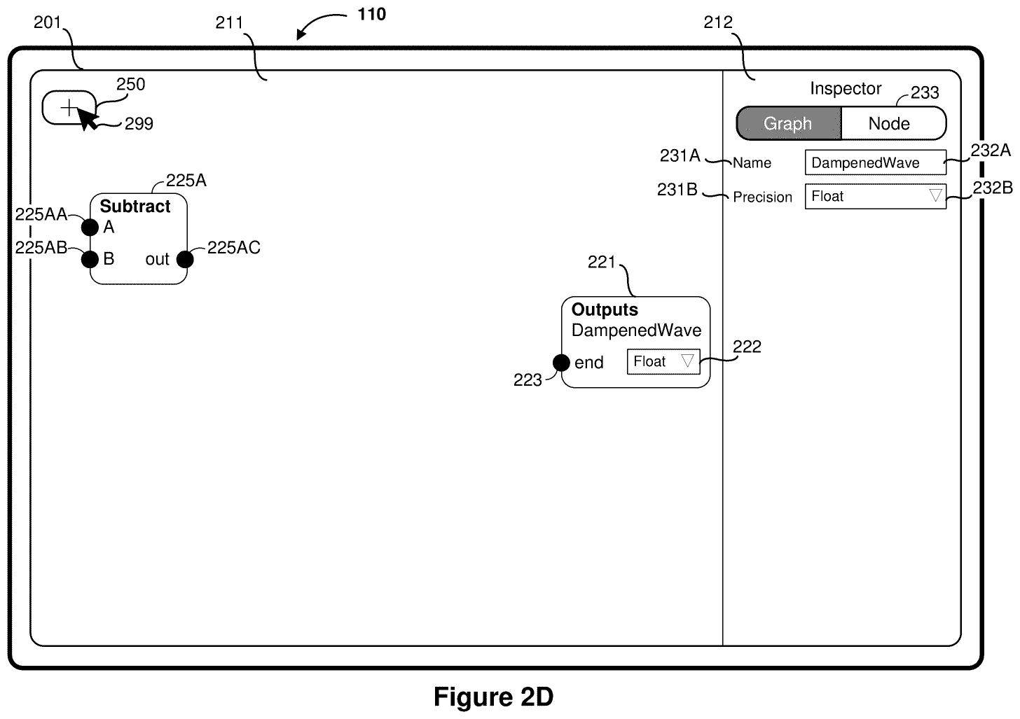

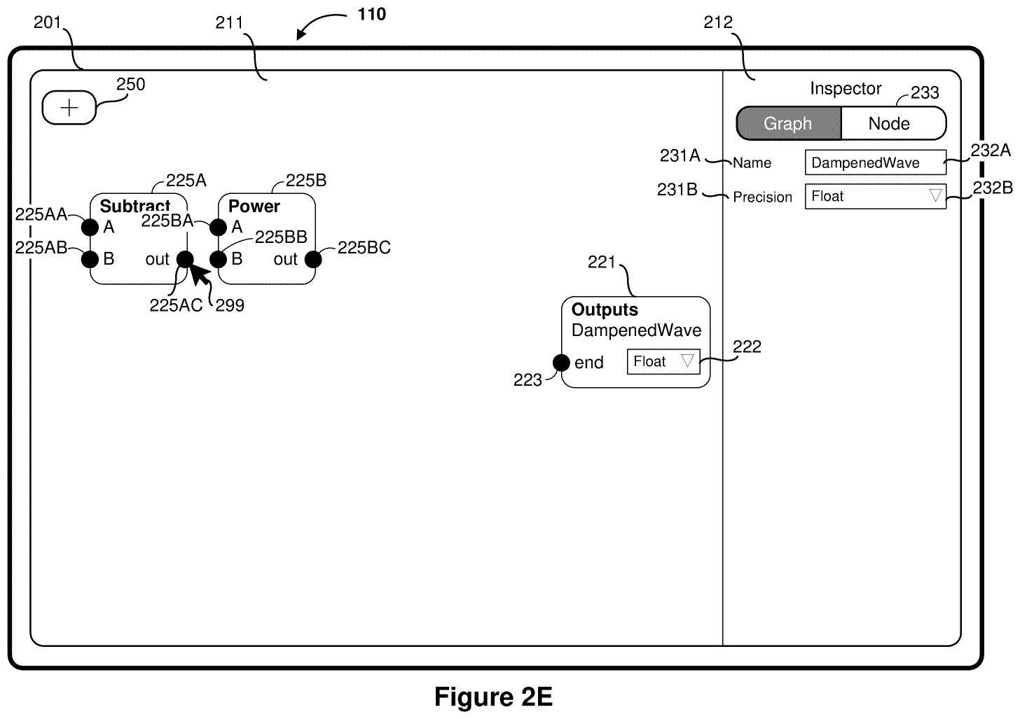

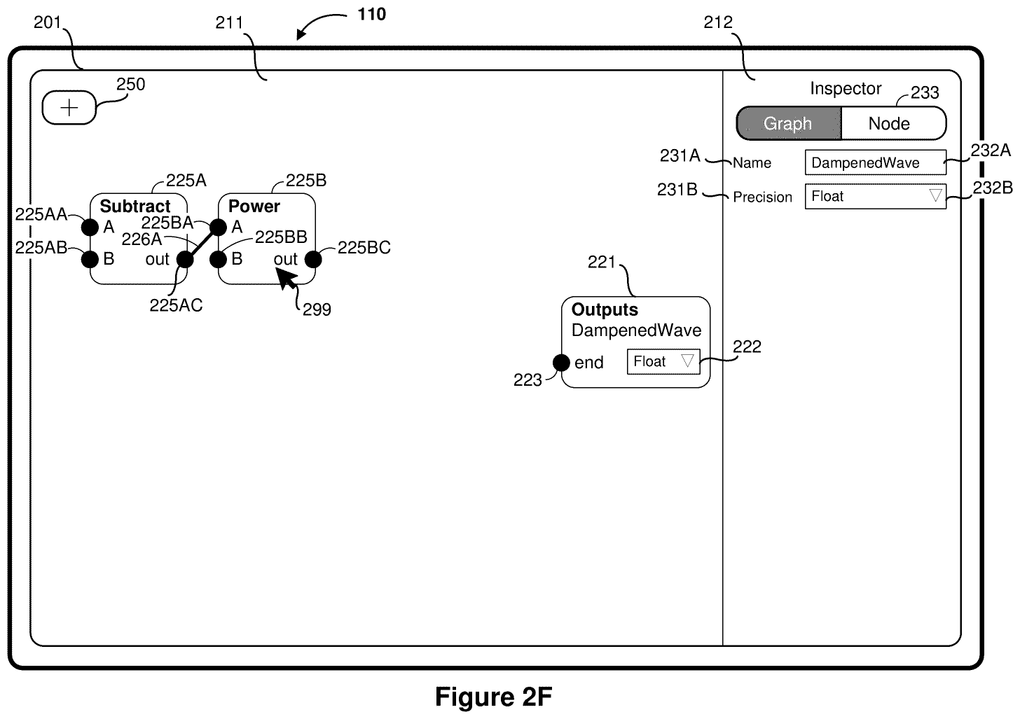

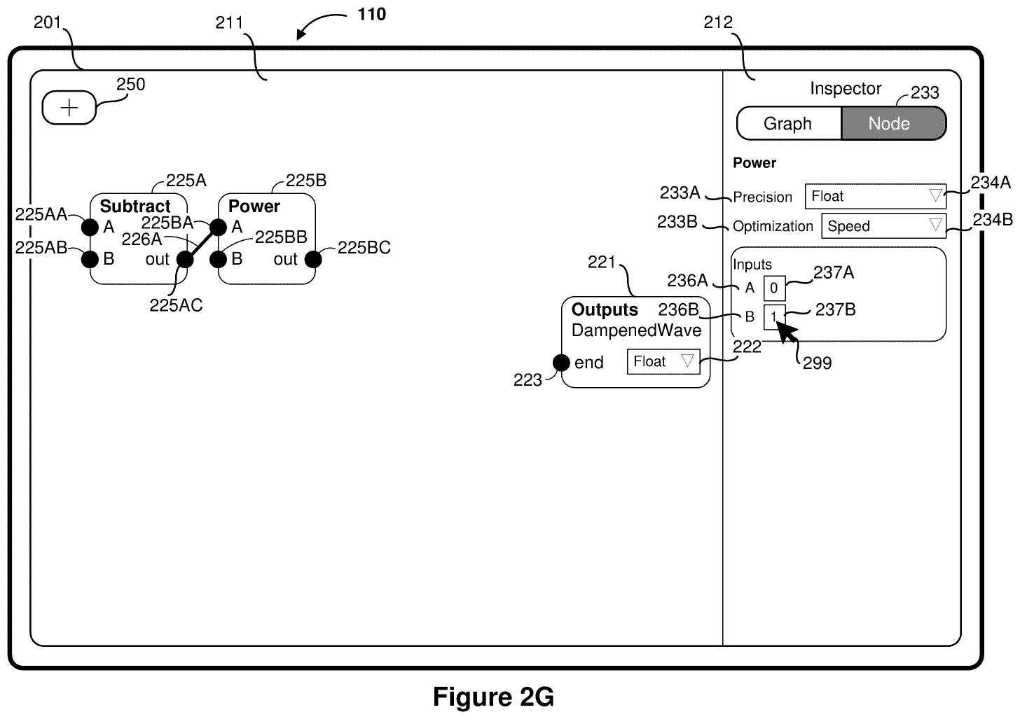

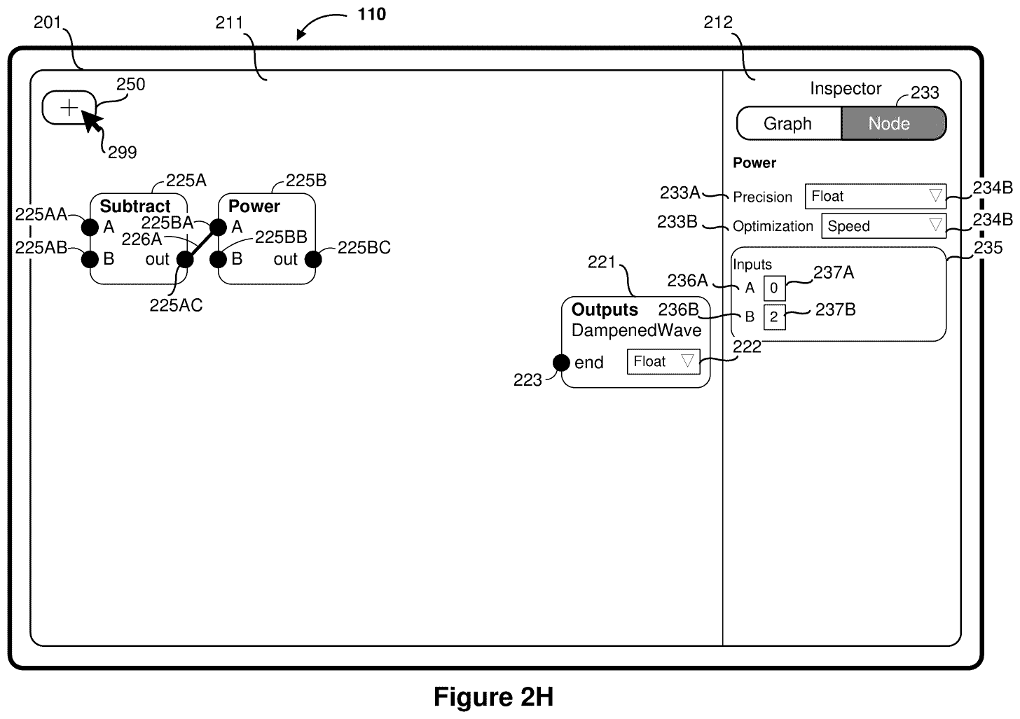

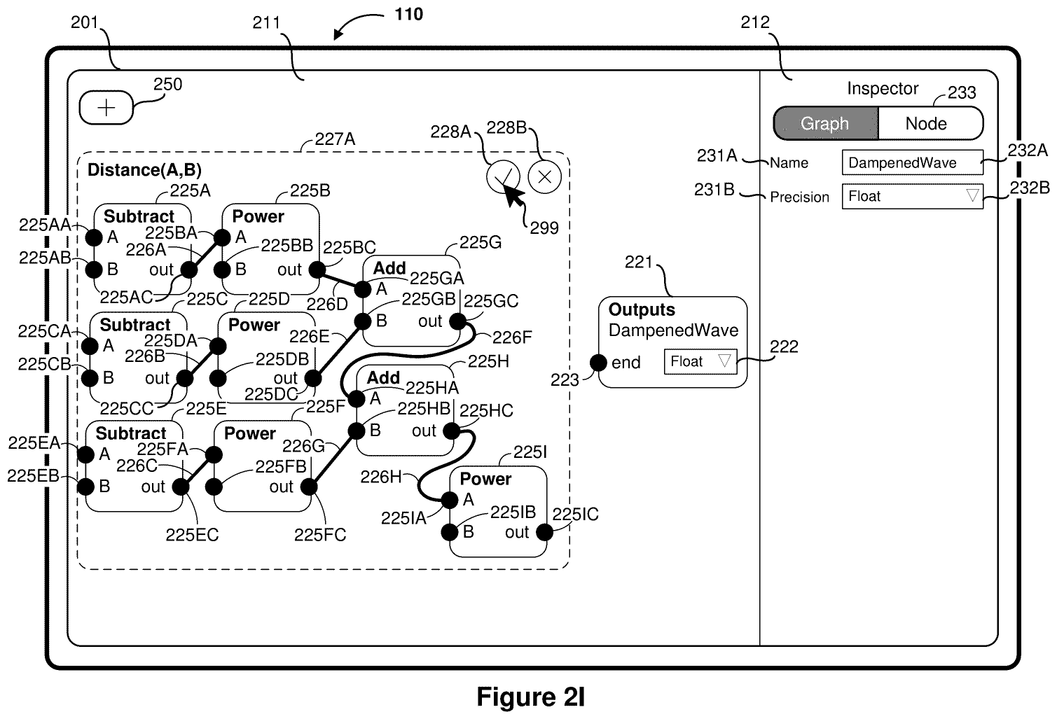

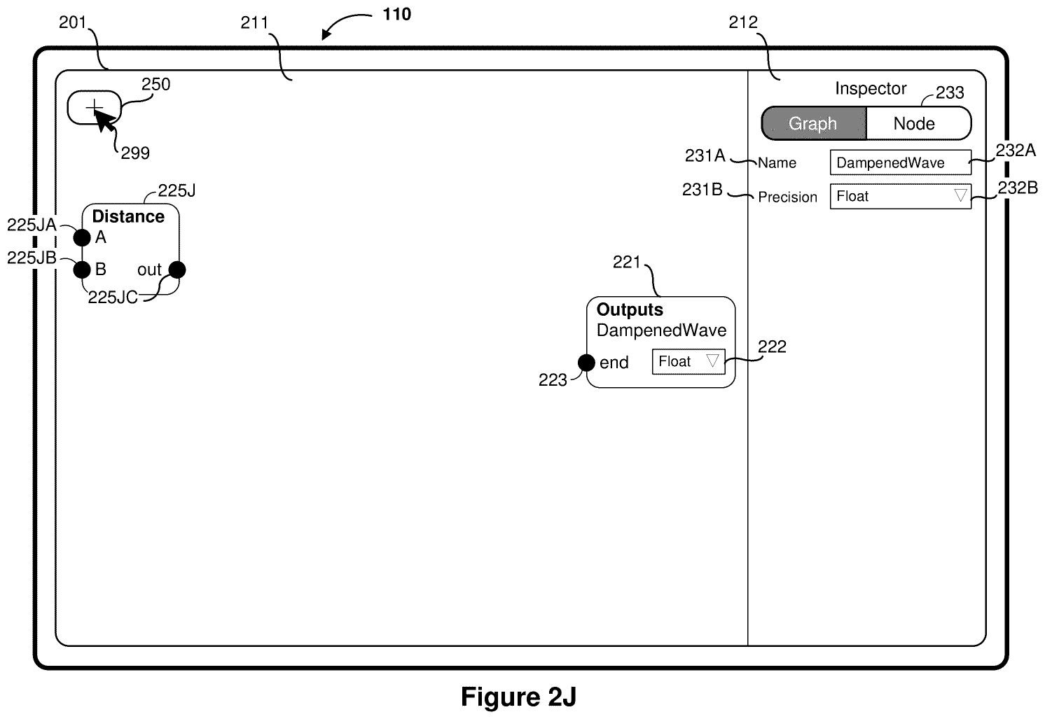

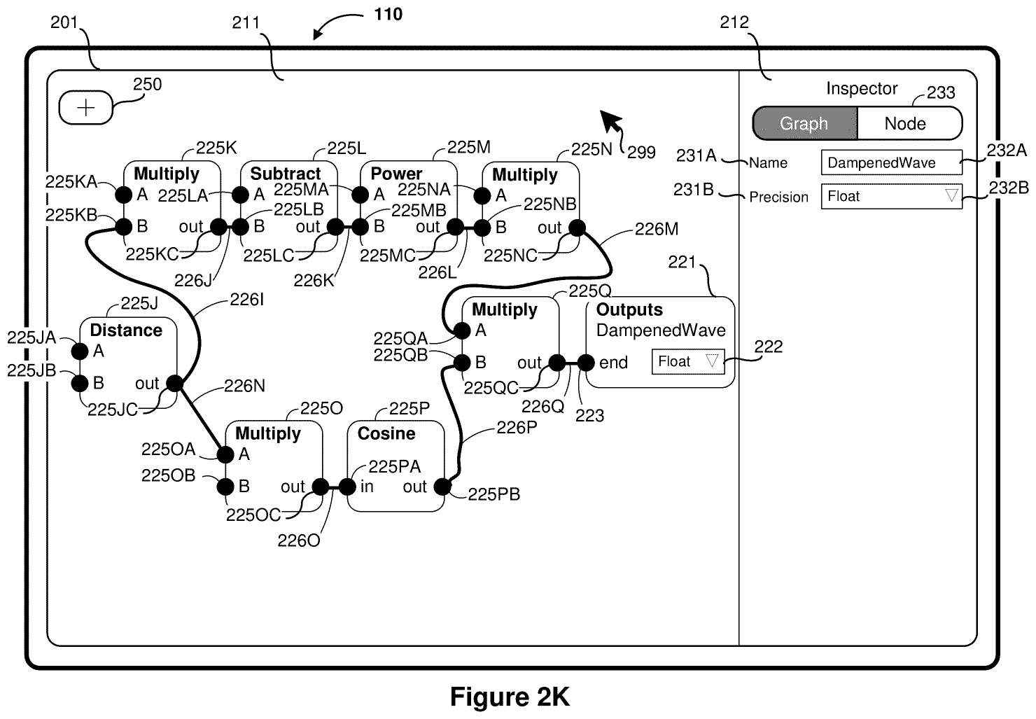

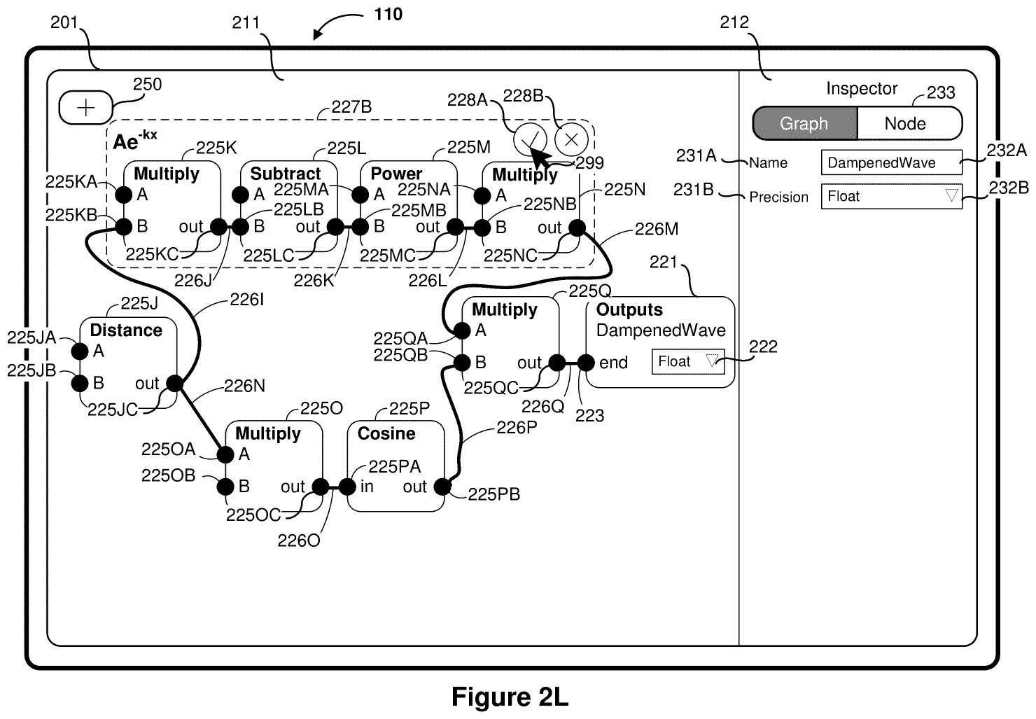

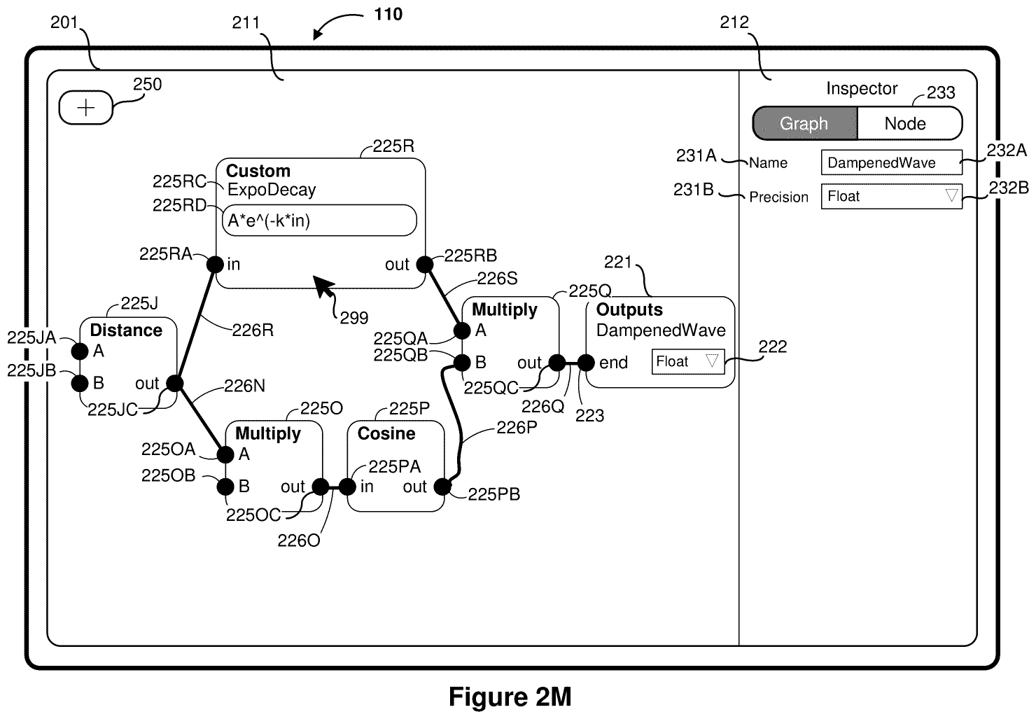

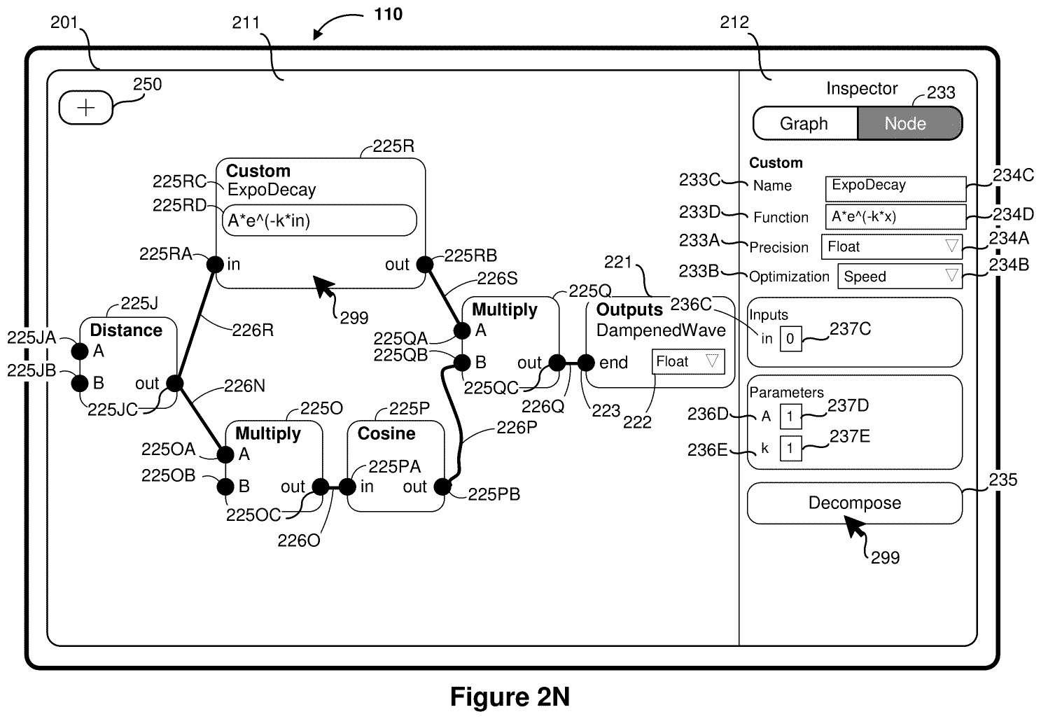

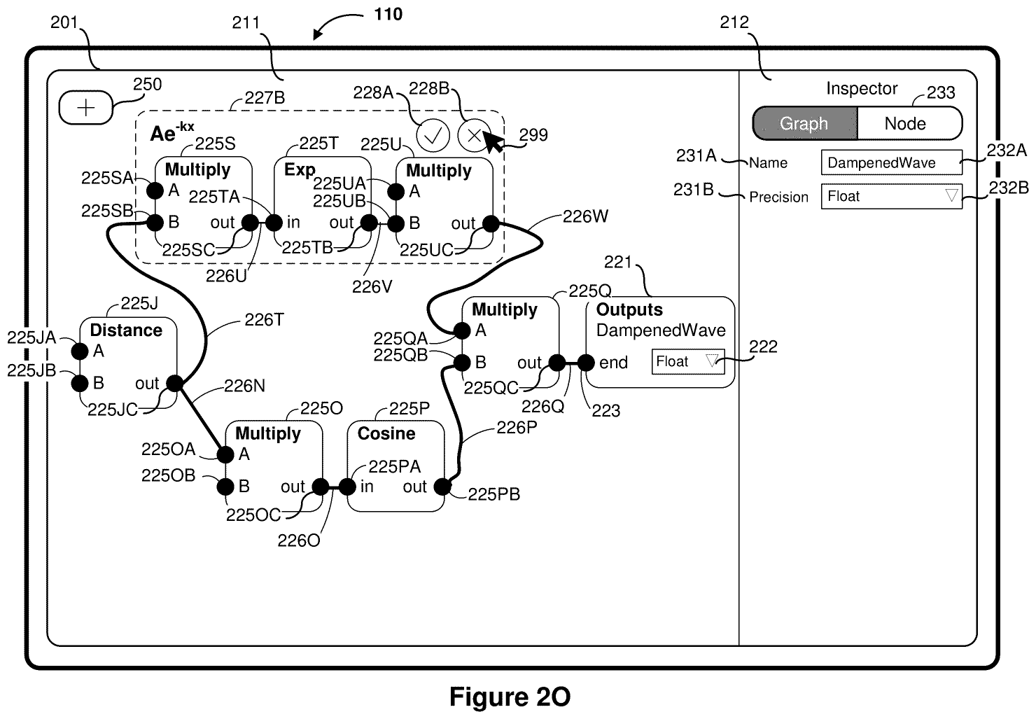

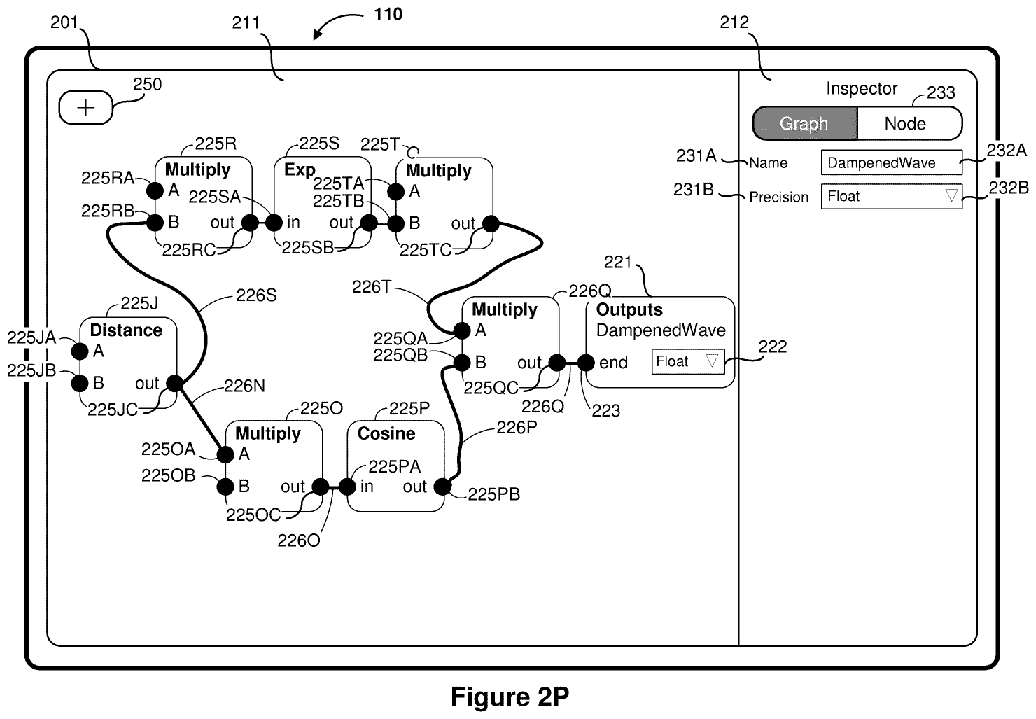

FIGS. 2A-2P illustrate a workflow for generating a node graph that outputs a value based on the distance between two points in a three-dimensional coordinate system. For example, a composing user may wish to compose a scene in which a size of a virtual object is related to the distance between the virtual object and a surface. As another example, a composing user may wish to compose a scene in which a color of a virtual object is related to the distance between an end user's left pointer fingertip and right pointer fingertip. In particular, FIGS. 2A-2P illustrate a workflow for generating a node graph that receives, as inputs, the location in a three-dimensional coordinate system of a first point (x₁, x₂, x₃) and the location in a three-dimensional coordinate system of a second point (y₁, y₂, y₃). The coordinates for each point may be received separately or as a vector. The node graph outputs a damped oscillation such that the value exponentially decays as the distance (D) increases, but also oscillated as the distance changes.

In particular, the distance between the two points is:

$$D = \sqrt{{( {x}_{1} - {y}_{1} )}^{2} + {( {x}_{2} - {y}_{2} )}^{2} + {( {x}_{3} - {y}_{3} )}^{2}} .$$

Further, the output (V) is:

$$V = {Ae}^{- kD} cos ( ω D ) ,$$

where A, k, and ω are settable parameters.

FIG. 2A illustrates the electronic device 110 displaying a graphical user interface (GUI) 201 for generating a node graph. The GUI 201 may be part of a prototyping application for composing a scene. In various implementations, an application of the electronic device 110 or a different electronic device executes to present the scene. In various implementations, the GUI 201 can be used to compose a two-dimensional scene and the electronic device 110 (or a different electronic device) executes to present the two-dimensional scene on a display. In various implementations, the GUI 201 can be used to compose a three-dimensional scene and the electronic device 110 (or a different electronic device) executes to present the three-dimensional scene in a three-dimensional environment, such as a virtual environment or in association with a representation of a physical environment.

The GUI 201 includes a node graph region 211 and an inspector region 212. The node graph region 211 includes an outputs node 221. The outputs node 221 includes a precision drop-down menu 222 and an end product port 223. The value that is received at the end product port 223 of the outputs node 221 is the output of the node graph. The precision drop-down menu 222 displays the type of output the node graph computes. For example, the type of output may be a number, a vector of numbers, or an array of numbers. The numbers may be Boolean, integers, single-precision floating-point, double-precision floating-point, etc. For example, the type of output may be a color, e.g., a vector of three (or, if there is an alpha channel, four) floating-point numbers. The user can change the output type of the node graph by interacting with the precision drop-down menu 222 to display a list of possible output types and selecting an output type from the list. In FIG. 2A, the precision drop-down menu 222 indicates that the output of the node graph is one single-precision floating-point number.

The inspector region 212 includes information regarding properties of the node graph. For example, the inspector region 212 includes a plurality of representations of properties of the node graph 231A-231B and a plurality of representations of values of the properties of the node graph 232A-232B. For example, the inspector region 212 includes a representation of a name property of the node graph 231A indicative of a name of the node graph and a representation of a value of the name property of the node graph 232A. In FIG. 2A, the representation of the name property of the node graph 231A is the text “Name” and the representation of the value of the name property of the node graph 232A is the text “DampenedWave”. The user can change the name of the node graph by interacting with the representation of the value of the name property of the node graph 232A and typing a new name. As another example, the inspector region 212 includes a representation of a precision property of the node graph 231B indicative of a default precision value for new nodes and a representation of a value of the precision property of the node graph 232B. In FIG. 2A, the representation of the precision property of the node graph 231B is the text “Precision” and the representation of the value of the precision property of the node graph 232B is the text “Float” (indicating a single-precision floating-point value). The user can change the default precision value by interacting with the representation of the value of precision property of the node graph 232B to display a list of possible precision values and selecting a precision value from the list.

The inspector region 212 includes a properties indicator 233 that indicates whether the inspector region 212 displays representations of properties of the node graph or representations of properties of a selected node.

The node graph region 211 further includes an add node affordance 250 for adding nodes to the node graph. The GUI 201 further includes a cursor 299 for interacting with the GUI 201. In FIG. 2A, the cursor 299 is displayed over the add node affordance 250.

FIG. 2B illustrates the GUI 201 of FIG. 2A in response to detecting activation of the add node affordance 250. For example, in various implementations, the electronic device 110 detects a click of a mouse button while the cursor 299 is displayed over the add node affordance 250. In various implementations, the electronic device 110 detects activation of a user interface clement in various ways. For example, in various implementations, the electronic device 110 detects a click of a mouse button while the cursor 299 is displayed over the user interface element. As another example, the electronic device 110 detects a press on a trackpad while the cursor 299 is displayed over the user interface element. As another example, in various implementations, the device detects a finger touching the electronic device 110 at the location the user interface element is displayed. As another example, in various implementations, the electronic device 110 detects a hand gesture while a user is looking at the user interface element. As another example, in various implementations, the electronic device 110 detects activation of a switch device while focus is directed to the user interface element.

In response to detecting activation of the add node affordance 250, the GUI 201 includes a nodes window 260. The nodes window 260 includes a plurality of node type drop-down menus 262A-262D. The nodes window 260 further includes a search bar 261 for searching for available nodes. Although only four node type drop-down menus 262A-262D are displayed in FIG. 2B, it is to be appreciated that there may be any number of node type drop-down menus 262A-262D. The plurality of node type drop-down menus 262A-262D include an artistic drop-down menu 262A. When the artistic drop-down menu 262A is activated, the artistic drop-down menu 262A expands to display representations of available artistic nodes. The plurality of node type drop-down menus 262A-262D include an input drop-down menu 262B. When the input drop-down menu 262B is activated, the input drop-down menu 262B expands to display representations of available input nodes. The plurality of node type drop-down menus 262A-262D include a math drop-down menu 262C. When the math drop-down menu 262C is activated, the math drop-down menu 262C expands to display representations of available math nodes. The plurality of node type drop-down menus 262A-262D include a utility drop-down menu 262D. When the utility drop-down menu 262D is activated, the utility drop-down menu 262D expands to display representations of available utility nodes.

In FIG. 2B, the cursor 299 is displayed over the math drop-down menu 262C.

FIG. 2C illustrates the GUI 201 in response to detecting activation of the math drop-down menu 262C. In response to detecting activation of the math drop-down menu 262C, the math drop-down menu 262C expands to display a plurality of representations of available math nodes 263A-263E. Although only five representations of available math nodes 263A-263E are displayed in FIG. 2C, it is to be appreciated that there may be any number of representations of available math nodes 263A-263E. The plurality of representations of available math nodes includes a representation of an available add node 263A. When the representation of an available add node 263A is activated, an add node is added to the node graph which takes A and B as inputs and outputs A+B. The plurality of representations of available math nodes includes a representation of an available cosine node 263B. When the representation of an available cosine node 263B is activated, a cosine node is added to the node graph which takes an input and outputs the cosine of the input. The plurality of representations of available math nodes includes a representation of an available power node 263C. When the representation of an available power node 263C is activated, a power node is added to the node graph which takes A and B as inputs and outputs A^{B}. The plurality of representations of available math nodes includes a representation of an available multiply node 263D. When the representation of an available multiply node 263D is activated, a multiply node is added to the node graph which takes A and B as inputs and outputs A×B. The plurality of representations of available math nodes includes a representation of an available subtract node 263E. When the representation of an available subtract node 263E is activated, an add node is added to the node graph which takes A and B as inputs and outputs A−B.

At a node, the output value is determined as a function of input values received at respective ports from other nodes. If no node is connected to a particular port, the output value is determined using a default value for the port.

In FIG. 2C, the cursor 299 is displayed over the representation of an available subtract node 263D.

FIG. 2D illustrates the GUI 201 in response to detecting activation of the representation of an available subtract node 263E. In response to detecting activation of the representation of an available subtract node 263E, the nodes window 260 ceases to be displayed and the node graph region 211 includes a first subtract node 225A. The first subtract node 225A has an A input port 225AA, a B input port 225AB, and an output port 225AC. When the A input port 225AA is connected to the output port of a node outputting x₁ and the B input port 225AB is connected to the output port of a node outputting y₁, the first subtract node 225A outputs (x₁−y₁) at the output port 225AC.

In FIG. 2D, the cursor 299 is displayed over the add node affordance 250.

FIG. 2E illustrates the GUI 201 in response to the user adding a power node to the node graph. For example, in various implementations, the user activates the add node affordance 250, activates the math drop-down menu 262C, and activates the representation of an available power node 263C. In response to the user adding a power node to the node graph, the node graph region 211 includes a first power node 225B. The first power node 225B has an A input port 225BA, a B input port 225BB, and an output port 225BC. When the A input port 225BA is connected to the output port of a node outputting (x₁−y₁) and the B input port 225BB is connected to the output port of a node outputting a value of 2, the first power node 225B outputs (x₁−y₁)² at the output port 225BC.

In FIG. 2E, the cursor 299 is displayed over the output port 225AC of the first subtract node 225A.

FIG. 2F illustrates the GUI 201 in response to the user connecting the output port 225AC of the first subtract node 225A and the A input port 225BA of the first power node 225B. For example, in various implementations, the user connects the output port 225AC of the first subtract node 225A and the A input port 225BA of the first power node 225B by pressing down a mouse button while the cursor 299 is at the location of the output port 225AC, moving the cursor 299 to the location of the A input port 225BA, and releasing the mouse button. In response to the user connecting the output port 225AC and the A input port 225BA, the node graph region 211 includes a first edge 226A between the output port 225AC and the A input port 225BA.

In FIG. 2F, the cursor 299 is displayed at the location of the first power node

225B.

FIG. 2G illustrates the GUI 201 in response to the user selecting the first power node 225B. For example, in various implementations, the user activates the first power node 225B. In response to the user selecting the first power node 225B, the inspector region 212 replaces the plurality of representations of properties of the node graph 231A-231B and the plurality of representations of values of the properties of the node graph 232A-232B with a plurality of representations of properties of a selected node 233A-233B, a plurality of representations of values of the properties of the selected node 234A-234B, a plurality of representations of the inputs 236A-236B, and a plurality of representations of default values of the inputs 237A-237B.

For example, the inspector region 212 includes a representation of a precision property of the selected node 233A indicative of a precision value for the selected node and a representation of a value of the precision property of the selected node 234A. In FIG. 2G, the representation of the precision property of the selected node 233A is the text “Precision” and the representation of the value of the precision property of the selected node is the text “Float” (indicating a single-precision floating-point value). The user can change the precision value of the first power node 225B by interacting with the representation of the value of precision property of the selected node 233B to display a list of possible precision values and selecting a precision value from the list.

As another example, the inspector region 212 includes a representation of an optimization property of the selected node 234B indicative of a mode for determining the output value of the selected node and a representation of a value of the optimization property of the selected node 234B. In FIG. 2G, the representation of the optimization property of the selected node 233B is the text “Optimization” and the representation of the value of the optimization property of the selected node is the text “Speed” (indicating the algorithm used to determine the output is optimized for speed rather than, for example, accuracy or power savings). The user can change the algorithm used to determine the output of the first power node 225B by interacting with the representation of the value of optimization property of the selected node 233B to display a list of possible optimizations and selecting an optimization from the list.

The inspector region 212 includes a representation of an A input 236A and a representation of a default value for the A input 237A. In FIG. 2G, the representation of the A input is the text “A” and the representation of the default value for the A input is the text “0”. The user can change the default value for the A input by interacting with the representation of the default value for the A input 237A and typing a new default value. The inspector region includes a representation of a B input 236B and a representation of a default value for the B input 237B. In FIG. 2G, the representation of the B input is the text “B” and the representation of the default value for the B input is the text “1”. The user can change the default value for the B input by interacting with the representation of the default value for the B input 237B and typing a new default value.

In FIG. 2G, the cursor 299 is displayed over the representation of the default value for the B input 237B.

FIG. 2H illustrates the GUI 201 in response to the user changing the default value for the B input 237B from one to two. In response to the user changing the default value for the B input 237B from one to two, the representation of the default value for the B input 237B is the text “2”. Thus, in FIG. 2H, when the A input port 225BA of the first power node 225B is connected to the output port of a node outputting (x₁−y₁) and the B input port 225BA of the first power node 225B is unconnected, the first power node 225B outputs (x₁−y₁₎² at the output port 225BC. Alternatively, a user can add an integer node that outputs the number 2 at an output port and connect that output port to the B input port 225BB.

In FIG. 2H, the cursor 299 is displayed over the representation of the add node affordance 250.

FIG. 21 illustrates the GUI 201 in response to the user adding, modifying, and connecting additional nodes to the node graph. In response to the user adding, modifying and connecting additional nodes to the node graph, the node graph region 211 further includes a second subtract node 225C. The second subtract node 225C has an A input port 225CA, a B input port 225CB, and an output port 225CC. When the A input port 225CA is connected to the output port of a node outputting x₂ and the B input port 225CB is connected to the output port of a node outputting y₂, the second subtract node 225C outputs (x₂−y₂) at the output port 225CC.

In response to the user adding, modifying and connecting additional nodes to the node graph, the node graph region 211 further includes a second power node 225D. The second power node 225D has an A input port 225DA, a B input port 225 DB, and an output port 225DC. When the A input port 225DA is connected to the output port of a node outputting (x₂−y₂) and the B input port 225 DB is connected to the output port of a node outputting 2 (or is unconnected because the default value for the B input is 2), the second power node 225D outputs (x₂−y₂)² at the output port 225DC.

In response to the user adding, modifying and connecting additional nodes to the node graph, the node graph region 211 further includes a third subtract node 225E. The third subtract node 225E has an A input port 225EA, a B input port 225EB, and an output port 225EC. When the A input port 225EA is connected to the output port of a node outputting x₃ and the B input port 225EB is connected to the output port of a node outputting y₃, the third subtract node 225E outputs (x₃−y₃) at the output port 225CC.

In response to the user adding, modifying and connecting additional nodes to the node graph, the node graph region 211 further includes a third power node 225F. The third power node 225F has an A input port 225FA, a B input port 225FB, and an output port 225FC. When the A input port 225FA is connected to the output port of a node outputting (x₃−y₃) and the B input port 225FB is connected to the output port of a node outputting 2 (or is unconnected because the default value for the B input is 2), the third power node 225F outputs (x₃−y₃)² at the output port 225FC.

In response to the user adding, modifying and connecting additional nodes to the node graph, the node graph region 211 further includes a first add node 225G. The first add node 225G has an A input port 225GA, a B input port 225GB, and an output port 225GC. When the A input port 225GA is connected to the output port of a node outputting (x₁−y₁)² and the B input port 225GB is connected to the output port of a node outputting (x₂−y₂)², the first add node 225G outputs (x₁−y₁)²+(x₂−y₂)² at the output port 225GC.

In response to the user adding, modifying and connecting additional nodes to the node graph, the node graph region 211 further includes a second add node 225H. The second add node 225H has an A input port 225HA, a B input port 225HB, and an output port 225HC. When the A input port 225HA is connected to the output port of a node outputting (x₁−y₁)²+(x₂−y₂)² and the B input port 225HB is connected to the output port of a node outputting (x₃−y₃)², the second add node 225H outputs (x₁−y₁)²+(x₂−y₂)²+(x₃−y₃)² at the output port 225GC.

In response to the user adding, modifying and connecting additional nodes to the node graph, the node graph region 211 further includes a fourth power node 225I. The fourth power node 2251 has an A input port 225IA, a B input port 225IB, and an output port 225IC. When the A input port 225IA is connected to the output port of a node outputting (x₁−y₁)²+(x₂−y₂)²+(x₃−y₃)² and the B input port 225IB is connected to the output port of a node outputting 0.5 (or is unconnected because the default value for the B input is 0.5), the fourth power node 225I outputs, at the output port 225IC:

$$D = \sqrt{{( {x}_{1} - {y}_{1} )}^{2} + {( {x}_{2} - {y}_{2} )}^{2} + {( {x}_{3} - {y}_{3} )}^{2}} .$$

To achieve this result, the node graph region 211 includes a second edge 226B connecting the output port 225CC of the second subtract node 225C to the A input port 225DA of the second power node 225D, a third edge 226C connecting the output port 225EC of the third subtract node 225E to the A input port 225FA of the third power node 225F, a fourth edge 226D connecting the output port 225BC of the first power node 225B to the A input port 225GA of the first add node 225G, a fifth edge 226E connecting the output port 225DC of the second power node 225D to the B input port 225GB of the first add node 225G, a sixth edge 226F connecting the output port 225GC of the first add node 225G to the A input port 225HA of the second add node 225H, a seventh edge 226G connecting the output port 225FC of the third power node 225F to the B input port 225HB of the second add node 225H, and an eighth edge 226H connecting the output port 225HC of the second add node to the A input port 225IA of the fourth power node 225I.

In FIG. 21, the electronic device 110 recognizes that the set of nodes 225A-225I are equivalent to a distance node. In response to recognizing that the set of nodes 225A-225I are equivalent to a distance node, the node graph region 211 includes a candidate substitution 227A in association with the set of nodes 225A-2251. In FIG. 21, the candidate substitution 227A is a dotted box surrounding the set of nodes 225A-225I. The candidate substitution 227A includes an affirm affordance 228A and a deny affordance 228B. In response to activation of the affirm affordance 228A, the set of nodes 225A-225I is replaced with an equivalent node and the candidate substitution 227A ceases to be displayed. In response to activation of the deny affordance 228B, the candidate substitution 227A ceases to be displayed without replacing the set of nodes 225A-225I.

In FIG. 21, the cursor 299 is displayed over the affirm affordance 228A.

FIG. 2J illustrates the GUI 201 in response to detecting activation of the affirm affordance 228A. In response to detecting activation of the affirm affordance 228A, the set of nodes 225A-225I are replaced with a distance node 225J. The distance node 225J has an A input port 225JA, a B input port 225JB, and an output port 225JC. When the A input port 225JA is connected to the output port of a node outputting (x₁, x₂, x₃) and the B input port 225JB is connected to the output port of a node outputting (y₁, y₂, y₃), the distance node 225J outputs D at the output port 225JC.

Alternatively, a user could reach the state of FIG. 2J by, starting from the state of FIG. 2A, activating the add node affordance 250, typing “Distance” into the search bar 261, and selecting a representation of an available distance node. In response, the node graph includes the distance node 225J.

In FIG. 2J, the cursor 299 is displayed over the add node affordance 250.

FIG. 2K illustrates the GUI 201 in response to the user adding, modifying, and connecting additional nodes to the node graph. In response to the user adding, modifying and connecting additional nodes to the node graph, the node graph region 211 further includes a first multiply node 225K. The first multiply node 225K has an A input port 225KA, a B input port 225KB, and an output port 225KC. When the A input port 225KA is connected to the output port of a node outputting k (or is unconnected because the default value for the A input is k) and the B input port 225KB is connected to the output port of a node outputting D, the first multiply node 225K outputs kD at the output port 225CC.

In response to the user adding, modifying and connecting additional nodes to the node graph, the node graph region 211 further includes a fourth subtract node 225L. The fourth subtract node 225L has an A input port 225LA, a B input port 225LB, and an output port 225LC. When the A input port 225LA is connected to the output port of a node outputting 0 (or is unconnected because the default value of the A input is 0) and the B input port 225LB is connected to the output port of a node outputting kD, fourth subtract node 225L outputs −kD at the output port 225LC.

In response to the user adding, modifying and connecting additional nodes to the node graph, the node graph region 211 further includes a fifth power node 225M. The fifth power node 225M has an A input port 225MA, a B input port 225MB, and an output port 225MC. When the A input port 225MA is connected to the output port of a node outputting e (or is unconnected because the default value of the A input is e) and the B input port 225MB is connected to the output port of a node outputting −kD, the fifth power node 225M outputs e^{-kD} at the output port 225MC.

In response to the user adding, modifying and connecting additional nodes to the node graph, the node graph region 211 further includes a second multiply node 225N. The second multiply node 225N has an A input port 225NA, a B input port 225NB, and an output port 225NC. When the A input port 225NA is connected to the output port of a node outputting A (or is unconnected because the default value of the A input is A) and the B input port 225NB is connected to the output port of a node outputting e^{-kD}, the second multiply node 225N outputs Ae^{-kD} at the output port 225MC.

In response to the user adding, modifying and connecting additional nodes to the node graph, the node graph region 211 further includes a third multiply node 225O. The third multiply node 225O has an A input port 225OA, a B input port 225OB, and an output port 225OC. When the A input port 225OA is connected to the output port of a node outputting D and the B input port 225OB is connected to the output port of a node outputting ω (or is unconnected because the default value of the B input is ω), the third multiply node 225O outputs ωD at the output port 2250C.

In response to the user adding, modifying and connecting additional nodes to the node graph, the node graph region 211 further includes a cosine node 225P. The cosine node 225P has an input port 225PA and an output port 225PB. When the input port 225PA is connected to the output port of a node outputting ωD, the cosine node 225P outputs cos((D) at the output port 225PB.

In response to the user adding, modifying and connecting additional nodes to the node graph, the node graph region 211 further includes a fourth multiply node 225Q. The fourth multiply node 225Q has an A input port 225QA, a B input port 225QB, and an output port 225QC. When the A input port 225QA is connected to the output port of a node outputting Ae^{-kD} and the B input port 225QB is connected to the output port of a node outputting cos(ωD), the fourth multiply node 225Q outputs Ae^{-kD}cos(ωD) at the output port 225QC.

To achieve this result, the node graph region 211 includes a ninth edge 226I connecting the output port 225JC of the distance node 225J to the B input port 225KB of the first multiply node 225K, a tenth edge 226J connecting the output port 225KC of the first multiply node 225K to the B input port 225LB of the fourth subtract node 225L, an eleventh edge 226K connecting the output port 225LC of the fourth subtract node 225L to the B input port 225MB of the fifth power node 225M, a twelfth edge 226L connecting the output port 225MC of the fifth power node 225M to the B input port 225NB of the second multiply node 225N, a thirteenth edge 226M connecting the output port 225NC of the second multiply node 225N to the A input port 225QA of the fourth multiply node 225Q, a fourteenth edge 226N connecting the output port 225JC of the distance node 225J to the A input port 225OA of the third multiply node 225O, a fifteenth edge 226O connecting the output port 225OC of the third multiply node 225O to the input port 225PA of the cosine node 225P, a sixteenth edge 226P connecting the output port 225PB of the cosine node 225P to the B input port 225QB of the fourth multiply node 225Q, and a seventeenth edge 226Q connecting the output port 225QC of the fourth multiply node 225Q to the end product port 223 of the outputs node 221.

In FIG. 2K, the cursor is displayed near the second multiply node 225N.

FIG. 2L illustrates the GUI 201 of FIG. 2K in response to (1) detecting a user input selecting the first multiply node 225K, the fourth subtract node 225L, the fifth power node 225M, and second multiply node 225N and (2) detecting a user input requesting a candidate substitution. In response to receiving the user inputs, the GUI 201 includes a functional candidate substitution 227B in association with the set of nodes 225K-225N. In FIG. 2L, the functional candidate substitution 227B is a dotted box surrounding the set of nodes 225K-225N. The functional candidate substitution 227B includes the affirm affordance 228A and the deny affordance 228B. In response to activation of the affirm affordance 228A, the set of nodes 225K-225N is replaced with an equivalent node and the functional candidate substitution 227B ceases to be displayed. In response to activation of the deny affordance 228B, the functional candidate substitution 227B ceases to be displayed without replacing the set of nodes 225K-225N.

In FIG. 2L, the cursor 299 is displayed over the affirm affordance 228A.

FIG. 2M illustrates the GUI 201 in response to detecting activation of the affirm affordance 228A. In response to detecting activation of the affirm affordance 228A, the set of nodes 225K-225N are replaced with a custom function node 225R. In various implementations, the GUI 201 reaches the state of FIG. 2M directly from the state of FIG. 2K in response to (1) detecting a user input selecting the first multiply node 225K, the fourth subtract node 225L, the fifth power node 225M, and second multiply node 225N and (2) detecting a user input requesting replacement of the selected nodes, e.g., via activation of a displayed compose affordance or using keyboard shortcut.

The custom function node 225R has an input port 225RA and an output port 225RB. When the input port 225RA is connected to the output port of a node outputting D, the custom function node 225R outputs Ae^{-kD} at the output port 225RB. Further, the ninth edge 2261 and the thirteenth edge 226M are replaced, respectively, by an eighteenth edge 226R connecting the output port 225JC of the distance node to the input port 225RA of the custom function node 225R and a nineteenth edge 226S connecting the output port 225RB of the custom function node 225R to the A input port 225QA of the fourth multiply node 225Q.

The custom function node 225R includes a representation of a name of the custom function node 225RC (e.g., the text “ExpoDecay”) and a representation of the custom function executed by the custom function node 225RD (e.g., the text “A*e\hat{ }(−k*in)”).

Alternatively, a user could reach the state of FIG. 2N by, starting from the state of FIG. 2J, activating the add node affordance 250, typing “Custom Function” into the search bar 261, selecting a representation of an available custom function node, changing the relevant parameters (e.g., typing the name and custom function), and adding the other nodes and edges of FIG. 2M.

In FIG. 2M, the cursor 299 is displayed over the custom function node 225R.

FIG. 2N illustrates the GUI 201 in response to detecting selection of the custom function node 225R. In response to the user selecting the custom function node 225R, the inspector region 212 replaces the plurality of representations of properties of the node graph 231A-231B and the plurality of representations of values of the properties of the node graph 232A-232B with a plurality of representations of properties of a selected node 233A-233C, a plurality of representations of values of the properties of the selected node 234A-234C, a representation of the input 236C, a representation of the default value of the input 237C, a plurality of representations of parameters 236D-236E, and a plurality of representations of values of the parameters 237D-237E.

For example, the inspector region 212 includes a representation of a precision property of the selected node 233A indicative of a precision value for the selected node and a representation of a value of the precision property of the selected node 234A. As another example, the inspector region 212 includes a representation of an optimization property of the selected node 233B indicative of a mode for determining the output of the selected node and a representation of a value of the optimization property of the selected node 234B.

For example, the inspector region 212 includes a representation of a name property of the selected node 233C indicative of a name of the selected node and a representation of a value of the name property of the selected node 234C. In FIG. 2N, the representation of the name property of the selected node 233C is the text “Name” and the representation of the value of the name property of the selected node 234C is the text “ExpoDecay”. The user can change the name of the custom function node 225R by interacting with the representation of the value of name property of the selected node 234C and typing a new name.

As another example, the inspector region 212 includes a representation of a function property of the selected node 233D indicative of a function executed by the selected node and a representation of a value of the function property of the selected node 234D. In FIG. 2N, the representation of the function property of the selected node 233D is the text “Function” and the representation of the value of the function property of the selected node 234C is the text “A*e\hat{ }(−k*x)”. The user can change the function of the custom function node 225R by interacting with the representation of the value of function property of the selected node 234C and typing a new function.

The inspector region 212 includes a representation of an input 236C and a representation of a default value for the input 237C. In FIG. 2G, the representation of the input is the text “in” and the representation of the default value for the input 237C is the text “0”. The user can change the default value for the input by interacting with the representation of the default value for the input 237C and typing a new default value. The inspector region includes a representation of an A parameter 236D and a representation of a value for the A parameter 237D. In FIG. 2N, the representation of the A parameter is the text “A” and the representation of the value for the A parameter 237D is the text “1”. The user can change the value for the A parameter by interacting with the representation of the value for the A parameter 237D and typing a new value. The inspector region includes a representation of a k parameter 236E and a representation of a value for the k parameter 237E. In FIG. 2N, the representation of the k parameter is the text “k” and the representation of the value for the k parameter 237E is the text “1”. The user can change the value for the k parameter by interacting with the representation of the value for the k parameter 237E and typing a new value.

The inspector region 212 includes a decompose affordance 235 for replacing the custom function node 225R with an equivalent set of nodes. In various implementations, the equivalent nodes are the set of nodes 225K-225N which were previously replaced. In various implementations, the equivalent set of nodes are new nodes.

In FIG. 2N, the cursor 299 is displayed over the decompose affordance 235.

FIG. 20 illustrates the GUI 201 in response to detecting activation of the decompose affordance 235. In response to detecting activation of the decompose affordance 235, the custom function node 225R is replaced with a fifth multiply node 225S, an exponential node 225T, and a sixth multiply node 225U. The fifth multiply node 225S has an A input port 225SA, a B input port 225SB, and an output port 225SC. When the A input port 225SA is connected to the output port of a node outputting −k (or is unconnected because the default value for the A input is −k) and the B input port 225SB is connected to the output port of a node outputting D, the fifth multiply node 225S outputs −kD at the output port 225SC.

The exponential node 225T has an input port 225TA and an output port 225TB. When the input port 225TA is connected to the output port of a node outputting −kD, the exponential node 225T outputs e^{-kD} at the output port 225TB.

The sixth multiply node 225U has an A input port 225UA, a B input port 225UB, and an output port 225UC. When the A input port 225UA is connected to the output port of a node outputting A (or is unconnected because the default value for the A input is A) and the B input port 225UB is connected to the output port of a node outputting e^{-kD}, the sixth multiply node 225U outputs Ae^{-kD} at the output port 225UC.

To achieve this result, the eighteenth edge 226R and nineteenth edge 226S are replaced with a twentieth edge 226T between the output port 225JC of the distance node 225J and the B input port 225SB of the fifth multiply node 225S, a twenty-first edge 226U between the output port 225SC of the fifth multiply node 225S and the input port 225TA of the exponential node 225T, a twenty-second edge 226V between the output port 225TB of the exponential node 225TB and B input port 225UB of the sixth multiply node 225U, and a twenty-third edge 226W between the output port 225UC of the sixth multiply node 225U and the A input port 225QA of the fourth multiply node 225Q.

In response to detecting activation of the decompose affordance 235, the node graph region 211 includes the functional candidate substitution 227B. In FIG. 20, the cursor is displayed over the deny affordance 228B.

FIG. 2P illustrates the GUI 201 of FIG. 20 in response to detecting activation of the deny affordance 228B. In response to detecting activation of the deny affordance, the node graph region 211 ceases to display the functional candidate substitution 227B.

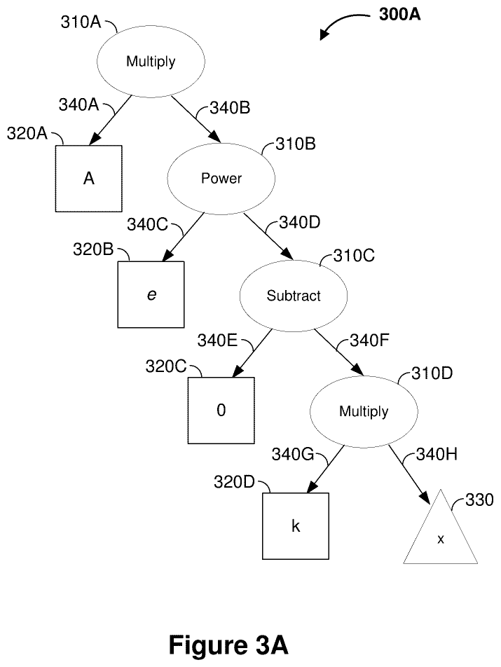

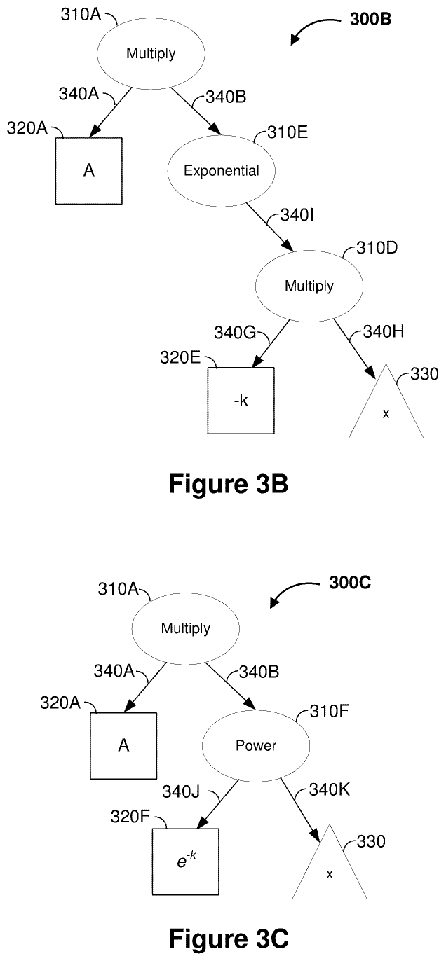

FIG. 3A illustrates the formula of the custom function node 225R of FIG. 2N (e.g., Ae^{-kD}) as a first tree graph 300A. The formula can be written in Polish Notation having a head representing the operation to be performed and a tail representing the one or more arguments of the operation. To generate the formula in Polish Notation form, the electronic device 110 works backwards from the second multiply node 225N to generate:

$${F}_{0} = multiply ( A , {F}_{1} ) ,$$

wherein Fo represents the formula of the custom function node 225, multiply (A, F₁) is the formula of the second multiply node 225N, and F₁ represents the formula of the preceding nodes in the set of nodes 225K-225N.

The electronic device 110 then determines F₁ working backwards from the fifth power node 225M to generate:

$${F}_{0} = multiply ( A , power ( e , {F}_{2} ) ) ,$$

wherein power(e, F₂) is the formula of the fifth power node 225M and F₂ represents the formula of the preceding nodes in the set of nodes 225K-225N.

The electronic device 110 then determines F₂ working backwards from the fourth subtract node 225L to generate:

$${F}_{0} = multiply ( A , power ( e , subtract ( 0 , {F}_{3} ) ) ) ,$$

wherein subtract(0, F₃) is the formula of the fourth subtract node 225L and F₃ represents the formula of the preceding nodes in the set of nodes 225K-225N (e.g., the formula of the first multiply node 225K).

The electronic device 110 then determines F₃ as the formula of the first multiply node 225K to generate, wherein multiply (k, x) is the formula of the first multiply node 225K:

$${F}_{0} = multiply ( A , power ( e , subtract ( 0 , multiply ( k , x ) ) ) ) .$$

Thus, the formula of the custom function node 225R (F₀) in Polish Notation is multiply (A, power(e, subtract(0, multiply(k, x)))).

The formula of the custom function node 225R can be represented in a first tree graph 300A. Each expression in Polish Notation is represented by a node representing the head with edges connected to a representation of each argument. Thus, the first tree graph 300A includes a first multiply node 310A with a first edge 340A connected to a representation of the constant A 320A and a second edge 340B connected to a first power node 310B. The first power node 310B is connected by a third edge 340C to a representation of the constant e 320B and is connected by a fourth edge 340D to a first subtract node 310C. The first subtract node 310C is connected by a fifth edge 340E to a representation of the constant 0 320C and is connected by a sixth edge 340F to a second multiply node 310D. The second multiply node 310D is connected by a seventh edge 340G to a representation of the constant k 320D and is connected by an eighth edge 340H to a representation of the input 330.

The electronic device 110 may apply various substitution rules to the tree graph (or, equivalently, to the formula in Polish Notation) to improve accuracy, speed, compactness, etc. In various implementations, the substitution rules are preprogrammed as part of the application illustrated in FIGS. 2A-2P. In various implementations, the substitution rules are provided by a user or a third-party developer. A non-exhaustive list of examples is provided for input values n and m and various constants (including C). For example, subtract(0, n) or multiply(−1, n) can be substituted with negate (n). Thus, the additive inverse of n can be determined with a more efficient algorithm than subtraction or multiplication.

As another example, negate (multiply(C, n)) can be substituted with multiply(−C, n). Similarly, negate(divide(C, n)) can be substituted with divide(−C, n). As another example, negate (subtract (C, n)) can be substituted with subtract (n, C). Thus, two nodes are reduced to one node. In general, the minus sign of a negate node can be removed by incorporating the negative sign into a constant or reversing the order of a subtract node. Similarly, the inverse of a reciprocal node can be removed by incorporating the negative exponent into a constant or reversing the order of a divide node.

As another example, power(n, 2) can be substituted with multiply(n, n). Thus, the square of n can be determined with a more efficient multiplication algorithm rather than a less efficient (but more general) power algorithm. Similarly, power(n, 0.5) can be substituted with sqrt(n). Thus, the square root of n can be determined with a more efficient square root algorithm than a less efficient (but more general) power algorithm. As another example, power(e, n) can be substituted with exponential(n). Thus, the exponential of n can be determined with a more efficient exponential algorithm than a less efficient (but more general) power algorithm. As another example, divide(1, n) or power(n, −1) can be substituted with reciprocal(n). Thus, the multiplicative inverse of n can be determined with a more efficient reciprocal algorithm than less efficient (but more general) divide or power algorithm.

In various implementations, the electronic device 110 may substitute a large number of nodes with other pre-programmed nodes, such as a distance node, an interpolation node, a rounding node, or a custom function node.

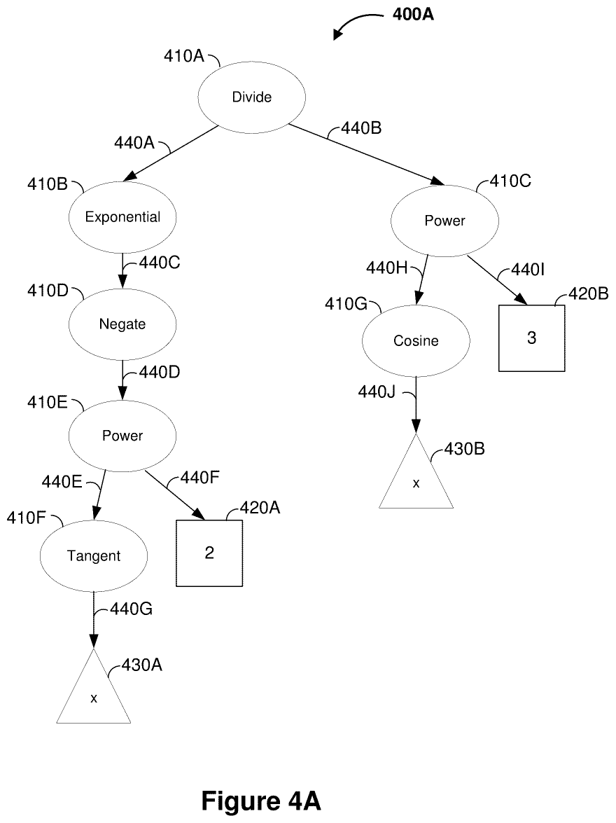

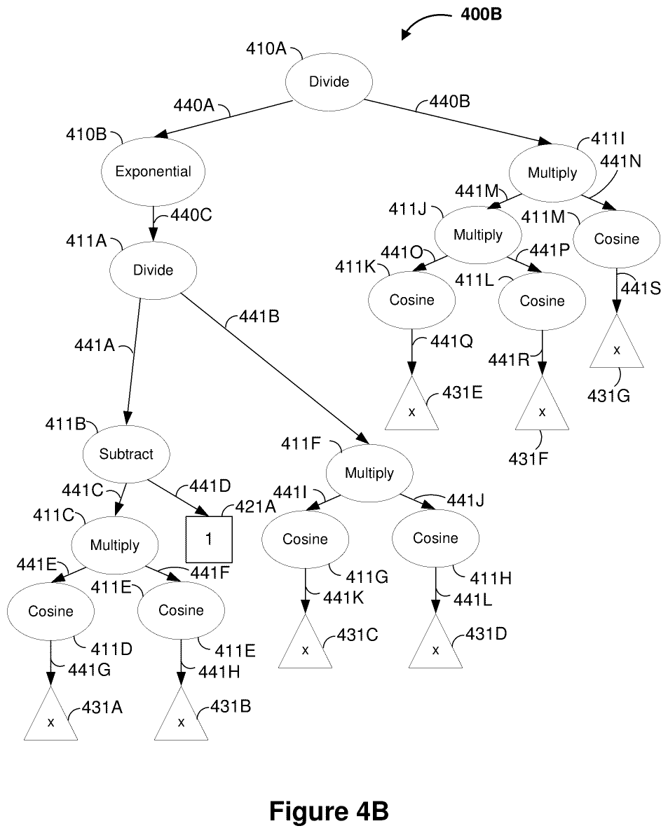

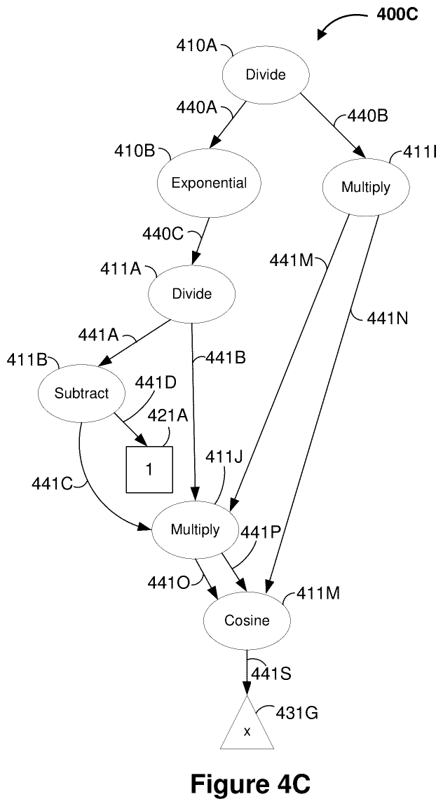

As discussed in additional detail with respect to FIGS. 4A-4C, in various implementations, the electronic device 110 may apply algebraic, trigonometric, logarithmic, or exponential identities to reduce the number of nodes, the number of computations, or the complexity of the computations.

For example, a difference of squares [subtract(multiply(n, m), multiply(n, m))] can be substituted with its factorization [multiply(subtract(n, m), add(n, m))]. Thus, the number of multiplications is reduced.

As another example, discussed further below respect to FIGS. 4A-4C, the square of a tangent [multiply(tangent(n), tangent(n))] can be substituted for an expression in terms of a cosine [divide(subtract(1, multiply (cosine(n), cosine(n))), multiply(cosine(n), cosine(n))] which may be particular useful if the cosine term is used elsewhere in tree graph.

As another example, a product can be converted into an addition using logarithms such that multiply(n, m) is substituted for exponential(add(logarithm(n), logarithm(m)). This may be useful to prevent overflow or underflow. Further, in a larger tree graph, the logarithm terms need only be calculated once and may save many multiplications.

As another example, a product can be factored out of an exponential to reduce the number of multiplications and nodes such that exponential(multiply(C, n)) is substituted for power(e^{C}, n).

FIG. 3B illustrates the formula of the custom function node 225R of FIG. 2N (e.g., Ae^{-kD}) as a second tree graph 300B. Applying some of the substitutions described above to improve efficiency, the second tree graph 300B the first multiply node 310A with a first edge 340A connected to the representation of the constant A 320A and the second edge 340B connected to a first exponential node 310E. The first exponential node 310E is connected by a ninth edge 3401 to the second multiply node 310D. The second multiply node 310D is connected by the seventh edge 340G to a representation of the constant −k 320E and is connected by the eighth edge 340H to the representation of the input 330.

It is to be appreciated that the representation of the formula of the custom function node 225R is not unique and may be optimized (or improved) in any number of ways. For example, whereas the second tree graph 300B of FIG. 3B includes substitutions to improve efficiency, the third tree graph 300C of FIG. 3C includes substitutions to reduce the number of nodes (at the expense of some efficiency). FIG. 3C illustrates the formula of the custom function node 225R of FIG. 2N (e.g., Ae^{KD}) as a third tree graph 300C. Applying some of the substitutions described above to reduce the number of nodes, the third tree graph 300C includes the first multiply node 310A with a first edge 340A connected to the representation of the constant A 320A and the second edge 340B connected to a second power node 310F. The second power node 310F is connected by a tenth edge 340J to a representation of the constant e^{-k} 320F and is connected by an eleventh edge 340K to the representation of the input 330.

FIGS. 4A-4C illustrate tree graphs of an example formula (different from the formula of the custom function node 225R). The example formula (Fₑ) is:

$${F}_{e} = \frac{{e}^{- {tan}^{2} ( x )}}{{cos}^{3} ( x )} .$$

Written in Polish Notation (according to one embodiment), the example formula is divide (exponential(negate(power(tangent(x), 2)))), power(cosine(x), 3)).

FIG. 4A illustrates the example formula as a first tree graph 400A. As noted above, each expression in Polish Notation is represented by a node representing the head with edges connected to a representation of each argument. Thus, the first tree graph 400A includes a first divide node 410A with a first edge 440A connected to a first exponential node 410B and a second edge 440B connected to a first power node 310B. The first exponential node 410B is connected by a third edge 440C to a first negate node 410D. The first negate node 410D is connected by a fourth edge 440D to a second power node 410E. The second power node 410E is connected by a fifth edge 440E to a first tangent node 410F and is connected by a sixth edge 440F to representation of the constant 2 420A. The first tangent node 410F is connected by a seventh edge 440G to a first representation of the input 430A.

The first power node 410C is connected by an eighth edge 440H to a first cosine node 410G and is connected by a ninth edge 4401 to a representation of the constant 3 420B. The first cosine node 410G is connected by a tenth edge 440J to a second representation of the input 430B.

FIG. 4B illustrates the example formula as a second tree graph 300B. In particular, FIG. 4B illustrates the example formula after applying a number of substitutions to reduce the number of different computations.

For example, by applying the trigonometric identities tan²(θ)=sin²(θ)/cos²(θ) and sin²(θ)=1−cos²(θ), the example formula is:

$${F}_{e} = \frac{{e}^{- \frac{1 - {cos}^{2} ( x )}{{cos}^{2} ( x )}}}{{cos}^{3} ( x )} .$$

Further, by distributing the minus sign in the exponent and expanding the powers, the example formula is:

$${F}_{e} = \frac{{e}^{( \frac{( cos ( x ) * cos ( x ) ) - 1}{( cos ( x ) * cos ( x ) )} )}}{( cos ( x ) * cos ( x ) ) * cos ( x )} .$$

Thus, the second tree graph 400B includes the first divide node 410A with the first edge 440A connected to the first exponential node 410B and the second edge 440B connected to a first multiply node 411I. The first exponential node 410B is connected by the third edge 440C to a second divide node 411A. The second divide node 411A is connected by an eleventh edge 441A to a first subtract node 411B and is connected by a twelfth edge 441B to a second multiply node 411F. The first subtract node 411B is connected by a thirteenth edge 441C to a third multiply node 411C and is connected by a fourteenth edge 441D to a representation of the constant 1 421A. The third multiply node 411C is connected by a fifteenth edge 441E to a second cosine node 411D and is connected by a sixteenth edge 441F to a third cosine node 411E. The second cosine node 411D is connected by a seventeenth edge 441G to a third representation of the input 431A. The third cosine node 411E is connected by an eighteenth edge 441H to a fourth representation of the input 431B.

The second multiply node 411F is connected by a nineteenth edge 441I to a fourth cosine node 411G and is connected by a twentieth edge 441J to a fifth cosine node 411H. The fourth cosine node 411G is connected by a twenty-first edge 441K to a fifth representation of the input 431C. The fifth cosine node 411H is connected by a twenty-second edge 441L to a sixth representation of the input 431D.

The first multiply node 441I is connected by a twenty-third edge 441M to a fourth multiply node 411K and is connected by a twenty-fourth edge 441N to sixth cosine node 411M. The fourth multiply node 411J is connected by a twenty-fifth edge 441O to a seventh cosine node 411K and is connected by a twenty-sixth edge 441P to an eighth cosine node 411L. The seventh cosine node 411K is connected by a twenty-seventh edge 441Q to a seventh representation of the input 431E. The eighth cosine node 411L is connected by a twenty-eighth edge 441R to an eighth representation of the input 431F. The sixth cosine node 411M is connected by a twenty-ninth edge 441S to a ninth representation of the input 431G.

Notably, the second tree graph 400B computes the cosine of the input seven times and the square of the cosine of the input three times. Accordingly, the second tree graph 400B can be reduced to eliminate this redundant computation.

To reduce the second tree graph 400B, each node is assigned a hash value. In various implementations, the hash values have the following characteristics: (1) hash values can be combined to form new hash values; (2) combining the hash values is non-communicative, e.g., the order of hash combination almost always affects the resulting hash value; and (3) hash values may be computed for most basic data types including integers, floating point numbers, and character strings. Further, if the hashes of two nodes are unequal, it can be inferred that the two nodes are similarly unequal. Conversely, if the hashes of two nodes are equal, further equality checks may confirm that the two nodes are equal.

In various implementations, the electronic device 110 generates a map including a one or more elements. Each element includes a unique hash and a representation of a node having the unique hash.

In various implementations, the electronic device 110 computes a hash for each node of the second tree graph 400B using a depth-first approach, e.g., generally right-to-left in the Polish Notation, but such that when computing the hash of a node, the hash value for each child node has a computed hash value. For each node representing the input, the electronic device 110 generates a hash. For example, the hash may be based on a name of the input (e.g., a character string). For each constant node, electronic device 110 generates a hash based on the constant itself.

For operation nodes, the electronic device 110 generates a child hash by combining the hashes of each child node. If the operation is commutative, such as add or multiply, the child nodes are sorted before combining the hashes. One sort strategy is alphanumerically based on string representation of the child node. Another sort strategy is to sort the hashes themselves in numerical order. If the operation is non-commutative, the child nodes are sorted in the order they are specified in the formula. For operation nodes, the electronic device 110 generates an operation hash for the operation type. For example, in various implementations, electronic device 110 stores a table of available operations and the operation hash is a hash of the position in the table. As another example, the operation hash is a hash of the string representation of the operation. For operation nodes, the electronic device 110 generates a hash by combining the operation hash with the child hash.

For each node, if the hash is not in the map, a new element is added with the hash value and a representation of the node. For each node, if the hash is in an entry of the map with a reference to an equivalent node, disconnect the edge between the parent node of the node and the node from the node and connect it, instead, to the equivalent node. Then, discard the unconnected node.

FIG. 4C illustrates the example formula as a directed acyclic graph 400C. In particular, FIG. 4C illustrates the second tree graph 400B of FIG. 4B reduced as described above. Thus, the directed acyclic graph 400C includes the first divide node 410A with the first edge 440A connected to the first exponential node 410B and the second edge 440B connected to a first multiply node 411I. The first exponential node 410B is connected by the third edge 440C to the second divide node 411A. The second divide node 411A is connected by the eleventh edge 441A to the first subtract node 411B and is connected by the twelfth edge 441B to the fourth multiply node 411J. The first subtract node 411B is connected by the thirteenth edge 441C to the fourth multiply node 411J and is connected by the fourteenth edge 441D to the representation of the constant 1 421A. The fourth multiply node 411J is connected by the twenty-fifth edge 441O to the sixth cosine node 411M and is connected by twenty-sixth edge 441P to the sixth cosine node 411M. The sixth cosine node 411M is connected by the twenty-ninth edge 441S to the ninth representation of the input 431G. The first multiply node 411I is connected by the twenty-third edge 441M to the fourth multiply node 411J and is connected by the twenty-fourth edge 441N to the sixth cosine node 411M,

Notably, the reduction of the second tree graph 400B of FIG. 4B to the directed acyclic graph 400C of FIG. 4C is reversible. In particular, given the directed acyclic graph 400C, the second tree graph 400B of FIG. 4B can be recreated. Further, the second tree graph 400B can, according to various substitution rules, be used to recreate the first tree graph 400A of FIG. 4A or a different tree graph representing an equivalent expression.

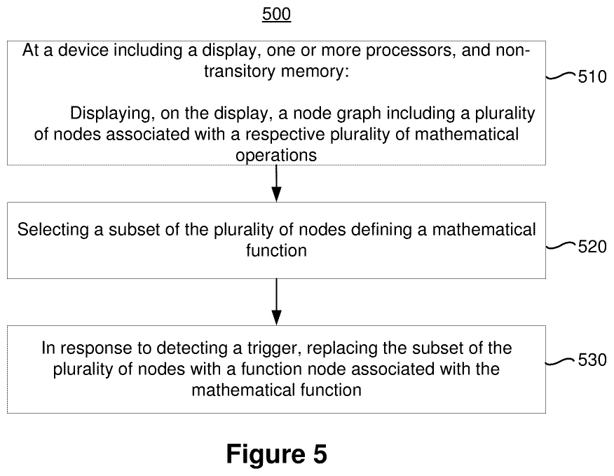

FIG. 5 is a flowchart representation of a method 500 of generating a node graph in accordance with some implementations. In various implementations, the method 500 is performed by a device with a display, one or more processors, and non-transitory memory. In some implementations, the method 500 is performed by processing logic, including hardware, firmware, software, or a combination thereof. In some implementations, the method 500 is performed by a processor executing instructions (e.g., code) stored in a non-transitory computer-readable medium (e.g., a memory).

The method 500 begins, in block 510, with the device displaying, on the display, a node graph including a plurality of nodes associated with a respective plurality of mathematical operations. For example, FIG. 2H illustrates a node graph region 211 including a plurality of nodes 225A-225I. As another example, FIG. 2K illustrates a node graph region 211 including a plurality of nodes 225J-225Q.

The method 500 continues, in block 520, with the device selecting a subset of the plurality of nodes defining a mathematical function. In various implementations, the device selects the subset of the plurality of nodes based on a user input selecting the subset of the plurality of nodes. For example, in FIG. 2L, the electronic device 110 selects the plurality of nodes 225K-225N based on a user input. In various implementations, the device selects the subset of the plurality of nodes automatically. For example, in FIG. 21, the electronic device 110 selects the plurality of nodes 225A-225I automatically. In various implementations, the device selects the subset of the plurality of nodes in response to recognizing an equivalent pre-defined function node associated with the mathematical function. For example, in FIG. 21, the electronic device 110 selects the plurality of nodes 225A-225I automatically in response to recognizing that a distance node performed the same function as the plurality of nodes. In various implementations, the device selects the subset of the plurality of nodes in response to recognizing a replacement set of nodes equivalent to the subset of the plurality of nodes that improves a performance characteristic. For example, in various implementations, the electronic device 110 automatically selects the plurality of nodes 225K-225N represented by the first tree graph 300A of FIG. 3A in response to recognizing that a replacement set of nodes represented by the second tree graph 300B of FIG. 3B reduces the number of computations or that a replacement set of nodes represented by the third tree graph 300C of FIG. 3C reduces the number of nodes.

The method 500 continues, in block 530, with the device, in response to detecting a trigger, replacing the subset of the plurality of nodes with a function node associated with the mathematical function. Thus, in various implementations, the method 500 includes detecting the trigger. In various implementations, detecting the trigger includes detecting a user input requesting replacement of the subset of the plurality of nodes with the function node. In various implementations, the user input is activation of a displayed compose affordance or a keyboard shortcut. In various implementations, the user input is activation of displayed affirm affordance as described further below. In various implementations, the user input is a resizing command to reduce a size of the node graph. In various implementations, detecting the trigger includes detecting that a size of the node graph has breached a threshold. In various implementations, the size of the node graph is a number of nodes of the node graph, an absolute area of the node graph, or a percentage of a node graph region occupied the node graph. For example, in FIG. 2J, the plurality of nodes 225A-225I are replaced by the distance node 225J in response to detecting activation of the affirm affordance 228A. As another example, in FIG. 2M, the plurality of nodes 225K-225N are replaced by the custom function node 225R in response to detecting activation of the affirm affordance 228A.

In various implementations, the function node includes a representation of the mathematical function. For example, in FIG. 2M, the custom function node 225R includes a the representation of the custom function executed by the custom function node 225RD.

In various implementations, the method 500 includes, prior to detecting the trigger, displaying a representation of the mathematical function in association with the plurality of nodes. For example, in FIG. 21, the node graph region 211 includes the candidate substitution 227A in association with the plurality of nodes 225A-225I. As another example, in FIG. 2L, the node graph region 211 includes the functional candidate substitution 227B in association with the plurality of nodes 225K-225N.

In various implementations, displaying the representation of the mathematical function in association with the plurality of nodes is performed in response to selecting the subset of the plurality of nodes.

In various implementations, the method 500 includes displaying an affirm affordance in association with representation of the mathematical function, wherein detecting the trigger includes detecting activation of the affirm affordance. For example, in FIG. 21, the candidate substitution 227A includes the affirm affordance 228A. As another example, in FIG. 2L, the functional candidate substitution 227B includes the affirm affordance 228A.

In various implementations, the method 500 further includes, after replacing the subset of the plurality of nodes with the function node, replacing the function node with a plurality of replacement nodes. For example, in FIG. 20, in response to detecting activation of the decompose affordance 235, the custom function node 225R is replaced with the plurality of nodes 225S-225U. Accordingly, in various implementations, the plurality of replacement nodes is different than the subset of the plurality of nodes. In various implementations, the plurality of replacement nodes is the subset of the plurality of nodes. For example, in various implementations, in response to detecting activation of the decompose affordance 235, the custom function node 225R is replaced with the subset of nodes 225K-225N. In various implementations, the plurality of replacement nodes differs from the subset of the plurality of nodes according to one or more substitution rules. In various implementations, the method 500 includes receiving the one or more substitution rules from a user or a third-party developer.

In various implementations, the method 500 does not include replacing the subset of the plurality of nodes with a function node as described in block 530. Rather, in various implementations, the method 500 includes, in response to detecting a trigger, replacing the subset of the plurality of nodes with the plurality of replacement nodes. In various implementations, the method 500 includes displaying a candidate substitution, such as a suggestion to implement one or more of the substitution rules described above. For example, in response to detecting one or more nodes defining negate (multiply(C, n)), a candidate substitution may display one or more nodes defining multiply(−C, n). As another example, in response to detecting one or more replacement nodes defining power(e, n), a candidate substitution may display one or more replacement nodes defining exponential(n). Such candidate substitutions may include an affirm affordance and a deny affordance as described above.

In various implementations, the function node performs an operation a set number of times. For example, the mathematic function may be multiplying an input variable by two four times, e.g., multiply(multiply(multiply(multiply(n, 2), 2), 2), 2). This can be reduced as repeat (multiply(n, 2), 4).

In various implementations, a user can export the node graph as a node graph file. In various implementations, the node graph file includes information regarding the plurality of nodes and connections between the plurality of nodes. In various implementations, the node graph file includes information regarding the function node. In various implementations, the information regarding the function node includes information identifying the function node as a function node and information describing the mathematical function.

However, some digital content creation applications may not be able to implement a function node. Thus, in various implementations, rather than including information regarding the function node, the node graph file includes information regarding the subset of the plurality of nodes and functional information describing the mathematical function in relation with the subset of the plurality of nodes. In various implementations, the functional information is stored in metadata of the node graph file. In various implementations, the functional information is stored in a local directory.

In various implementations, a user can import the node graph from a node graph file. As noted above, in various implementations, the node graph file includes information regarding the function node. In various implementations, the node graph file includes information regarding the subset of the plurality of nodes and functional information describing the mathematical function in relation with the subset of the plurality of nodes. The electronic device audits the subset of the plurality of nodes to confirm that they are described by the mathematical function. If the subset of the plurality of nodes are described by the mathematical function, the electronic device replaces the subset of the plurality of nodes with the function node. If the subset of the plurality of nodes are described by a different mathematical function, the electronic device does not replace the subset of the plurality of nodes and may notify the user that there is a mathematical function that does not appear to be equivalent to the subset of the plurality of nodes.

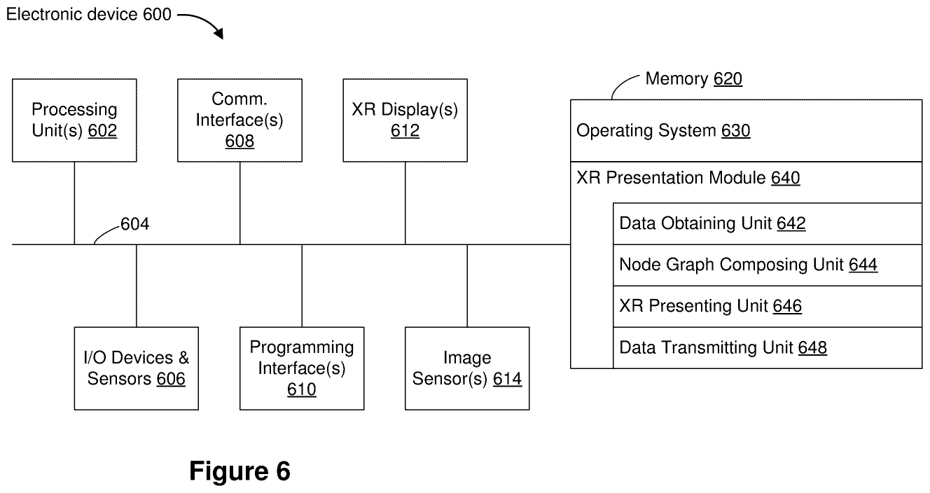

FIG. 6 is a block diagram of an electronic device 600 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 600 includes one or more processing units 602 (e.g., microprocessors, ASICs, FPGAs, GPUs, CPUs, processing cores, and/or the like), one or more input/output (I/O) devices and sensors 606, one or more communication interfaces 608 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 610, one or more XR displays 612, one or more optional interior- and/or exterior-facing image sensors 614, a memory 620, and one or more communication buses 604 for interconnecting these and various other components.

In some implementations, the one or more communication buses 604 include circuitry that interconnects and controls communications between system components. In some implementations, the one or more I/O devices and sensors 606 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more XR displays 612 are configured to present XR content to the user. In some implementations, the one or more XR displays 612 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more XR displays 612 correspond to diffractive, reflective, polarized, holographic, etc. waveguide displays. For example, the electronic device 600 includes a single XR display. In another example, the electronic device 600 includes an XR display for each eye of the user. In some implementations, the one or more XR displays 612 are capable of presenting AR, MR, and/or VR content.

In various implementations, the one or more XR displays 612 are video passthrough displays which display at least a portion of a real scene as an image captured by a scene camera. In various implementations, the one or more XR displays 612 are optical see-through displays which are at least partially transparent and pass light emitted by or reflected off the real scene.

In some implementations, the one or more image sensors 614 are configured to obtain image data that corresponds to at least a portion of the face of the user that includes the eyes of the user (any may be referred to as an eye-tracking camera). In some implementations, the one or more image sensors 614 are configured to be forward-facing so as to obtain image data that corresponds to the physical environment as would be viewed by the user if the electronic device 600 was not present (and may be referred to as a scene camera). The one or more optional image sensors 614 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 620 includes high-speed random-access memory, such as DRAM, SRAM, DDR RAM, or other random-access solid-state memory devices. In some implementations, the memory 620 includes non-volatile memory, such as one or more magnetic disk storage devices, optical disk storage devices, flash memory devices, or other non-volatile solid-state storage devices. The memory 620 optionally includes one or more storage devices remotely located from the one or more processing units 602. The memory 620 comprises a non-transitory computer readable storage medium. In some implementations, the memory 620 or the non-transitory computer readable storage medium of the memory 620 stores the following programs, modules and data structures, or a subset thereof including an optional operating system 630 and an XR presentation module 640.

The operating system 630 includes procedures for handling various basic system services and for performing hardware dependent tasks. In some implementations, the XR presentation module 640 is configured to present XR content to the user via the one or more XR displays 612. To that end, in various implementations, the XR presentation module 640 includes a data obtaining unit 642, a node graph composing unit 644, an XR presenting unit 646, and a data transmitting unit 648.

In some implementations, the data obtaining unit 642 is configured to obtain data (e.g., presentation data, interaction data, sensor data, location data, etc.). The data may be obtained from the one or more processing units 602 or another electronic device. To that end, in various implementations, the data obtaining unit 642 includes instructions and/or logic therefor, and heuristics and metadata therefor.

In some implementations, the node graph composing unit 644 is configured to provide an interface for generating a node graph. To that end, in various implementations, the node graph composing unit 644 includes instructions and/or logic therefor, and heuristics and metadata therefor.

In some implementations, the XR presenting unit 646 is configured to present XR content via the one or more XR displays 612. To that end, in various implementations, the XR presenting unit 646 includes instructions and/or logic therefor, and heuristics and metadata therefor.

In some implementations, the data transmitting unit 648 is configured to transmit data (e.g., presentation data, location data, etc.) to the one or more processing units 602, the memory 620, or another electronic device. To that end, in various implementations, the data transmitting unit 648 includes instructions and/or logic therefor, and heuristics and metadata therefor.

Although the data obtaining unit 642, the node graph composing unit 644, the XR presenting unit 646, and the data transmitting unit 648 are shown as residing on a single electronic device 600, it should be understood that in other implementations, any combination of the data obtaining unit 642, the node graph composing unit 644, the XR presenting unit 646, and the data transmitting unit 648 may be located in separate computing devices.

Moreover, FIG. 6 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 6 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device having a display, one or more processors, and non-transitory memory:
displaying, on the display, a node graph including a plurality of nodes associated with a respective plurality of mathematical operations;
selecting a subset of the plurality of nodes defining a mathematical function; and
in response to detecting a trigger, replacing the subset of the plurality of nodes with a function node associated with the mathematical function.

2. The method of claim 1, further comprising, prior to detecting the trigger, displaying a representation of the mathematical function in association with the plurality of nodes.

3. The method of claim 2, wherein displaying the representation of the mathematical function in association with the plurality of nodes is performed in response to selecting the subset of the plurality of nodes.

4. The method of claim 2, further comprising displaying an affirm affordance in association with the representation of the mathematical function, wherein detecting the trigger includes detecting activation of the affirm affordance.

5. The method of claim 1, wherein selecting the subset of the plurality of nodes is based on a user input selecting the subset of the plurality of nodes.

6. The method of claim 1, selecting the subset of the plurality of nodes is performed automatically.

7. The method of claim 6, wherein selecting the subset of the plurality of nodes is performed in response to recognizing an equivalent pre-defined function node associated with the mathematical function.

8. The method of claim 6, wherein selecting the subset of the plurality of nodes is performed in response to recognizing a replacement set of nodes equivalent to the subset of the plurality of nodes that improves a performance characteristic.

9. The method of claim 1, wherein detecting the trigger includes detecting a user input requesting replacement of the subset of the plurality of nodes with the function node.

10. The method of claim 1, wherein detecting the trigger includes detecting that a size of the node graph has breached a threshold.

11. The method of claim 1, wherein the function node includes a representation of the mathematical function.

12. The method of claim 1, further comprising, after replacing the subset of the plurality of nodes with the function node, replacing the function node with a plurality of replacement nodes.

13. The method of claim 12, wherein replacing the function node with the plurality of replacement nodes is performed in response to detecting a user input requesting replacement of the function node with the plurality of replacement nodes.

14. The method of claim 12, wherein the plurality of replacement nodes is the subset of the plurality of nodes.

15. The method of claim 12, wherein the plurality of replacement nodes is different than the subset of the plurality of nodes.

16. The method of claim 15, wherein the plurality of replacement nodes differs from the subset of the plurality of nodes according to one or more substitution rules.

17. The method of claim 16, further comprising receiving the one or more substitution rules from a user or a third-party developer.

18. A device comprising:
a display;
non-transitory memory; and
one or more processors to:
display, on the display, a node graph including a plurality of nodes associated with a respective plurality of mathematical operations;
select a subset of the plurality of nodes defining a mathematical function; and
in response to detecting a trigger, replace the subset of the plurality of nodes with a function node associated with the mathematical function.

19. The device of claim 18, wherein the one or more processors are to select the subset of the plurality of nodes automatically.

20. A non-transitory memory storing one or more programs, which, when executed by one or more processors of a device including a display, cause the device to:
display, on the display, a node graph including a plurality of nodes associated with a respective plurality of mathematical operations;
select a subset of the plurality of nodes defining a mathematical function; and
in response to detecting a trigger, replace the subset of the plurality of nodes with a function node associated with the mathematical function.
